(19) United States
(12) Patent Application Publication
(10) Pub. No.: US 2005/0240727 A1
(43) Pub. Date: Oct. 27, 2005

(54) Method and system for managing storage area networks

(76) Inventors: Shishir Shah, Irvine, CA (US); Hue Nguyen, Fountain Valley, CA (US)

Correspondence Address: KLEIN, O'NEILL & SINGH, 2 PARK PLAZA, SUITE 510, IRVINE, CA, 92614, US

(21) Appl. No.: 11/099,751

(22) Filed: Apr. 6, 2005

Related U.S. Application Data
(60) Provisional application No. 60/565,060, filed on Apr. 23, 2004.

(51) Int. Cl. G06F 12/00

(52) U.S. Cl. 711/114; 711/170

(57) ABSTRACT

A method and system for creating a logical unit number (“LUN”) in a storage area network is provided. The method includes selecting a storage sub-system from a list of available storage sub-subsystems for which the LUN is created in a wizard like setting, wherein a display attribute may be used for depicting connectivity of the storage sub-system to a server and/or host bus adapter; configuring the LUN for the selected storage sub-system; and assigning the LUN to at least one server. The method also includes, extending, shrinking and/or deleting an existing LUN by using a graphical user interface and selecting the LUN associated with a storage sub-system and a server. The method also includes partitioning a LUN in a wizard like setting by assigning a partition size, and drive letter.

### CROSS REFERENCE TO RELATED APPLICATIONS

This patent application claims priority under 35 U.S.C.§ 119(e)(1) to the following provisional patent application: Ser. No. 60/565,060 filed on Apr. 23, 2004, entitled “Method and System for Managing Storage Area Networks”, Attorney Docket number QN1097.USPROV, the disclosure of which is incorporated herein by reference in its entirety.

### BACKGROUND

1. Field of the Invention

The present invention relates to storage systems, and more particularly, to managing storage area networks.

2. Background of the Invention

Storage area networks (“SAN”) are commonly used to store and access data. SAN is a high-speed sub-network of shared storage devices, for example, disks and tape drives. A computer system (may also be referred to as a “host”) can access data stored in the SAN.

Typical SAN architecture makes storage devices available to all servers that are connected using a computer network, for example, a local area network or a wide area network. The term server in this context means any computing system or device coupled to a network that manages network resources. For example, a file server is a computer and storage device dedicated to storing files. Any user on the network can store files on the server. A print server is a computer that manages one or more printers, and a network server is a computer that manages network traffic. A database server is a computer system that processes database queries.

Various components and standard interfaces are used to move data from host systems to storage devices in a SAN. Fibre channel is one such standard. Fibre channel (incorporated herein by reference in its entirety) is an American National Standard Institute (ANSI) set of standards, which provides a serial transmission protocol for storage and network protocols such as HIPPI, SCSI (small computer system interface), IP, ATM and others. Fibre channel provides an input/output interface to meet the requirements of both channel and network users.

Host systems often communicate via a host bus adapter (“HBA”) using the “PCI” bus interface. PCI stands for Peripheral Component Interconnect, a local bus standard that was developed by Intel Corporation®. The PCI standard is incorporated herein by reference in its entirety. Most modern computing systems include a PCI bus in addition to a more general expansion bus (e.g. the ISA bus). PCI is a 64-bit bus and can run at clock speeds of 33 or 66 MHz.

PCI-X is a standard bus that is compatible with existing PCI cards using the PCI bus. PCI-X improves the data transfer rate of PCI from 132 MBps to as much as 1 GBps. The PCI-X standard was developed by IBM®, Hewlett Packard Corporation® and Compaq Corporation® to increase performance of high bandwidth devices, such as Gigabit Ethernet standard and Fibre Channel Standard, and processors that are part of a cluster.

The iSCSI standard (incorporated herein by reference in its entirety) is based on Small Computer Systems Interface (“SCSI”), which enables host computer systems to perform block data input/output (“I/O”) operations with a variety of peripheral devices including disk and tape devices, optical storage devices, as well as printers and scanners. A traditional SCSI connection between a host system and peripheral device is through parallel cabling and is limited by distance and device support constraints. For storage applications, iSCSI was developed to take advantage of network architectures based on Fibre Channel and Gigabit Ethernet standards. iSCSI leverages the SCSI protocol over established networked infrastructures and defines the means for enabling block storage applications over TCP/IP networks. iSCSI defines mapping of the SCSI protocol with TCP/IP.

The iSCSI architecture is based on a client/server model. Typically, the client is a host system such as a file server that issues a read or write command. The server may be a disk array that responds to the client request. Devices that request I/O processes are called initiators. Targets are devices that perform operations requested by initiators. Each target can accommodate up to a certain number of devices, known as logical units, and each is assigned a Logical Unit Number (LUN).

Microsoft Corporation® that markets Windows Server 2003® and Windows Storage Server 2003® provides a virtual disk service (“VDS”) program for managing storage configurations under Microsoft Server Operating Systems. FIG. 2 shows a block diagram of VDS architecture 200. VDS architecture 200 includes disks 205 and drives 208 that are coupled to software interface 207 and hardware interface layer 210 that are coupled to VDS 201. VDS architecture 200 allows storage hardware vendors to write hardware specific code that is then translated into VDS hardware interface 210. Software interface 207 also provides a vendor independent interface.

LUN(s) 206 throughout this specification means a logical unit number, which is a unique identifier, on a Parallel SCSI or Fiber Channel or iSCSI target.

Disk management utility 202, management application 203 and command line interface utility 204 allow a SAN vendor to use application-programming interfaces (“APIs”) to build applications/solutions for managing SANs. Management application 203 may be used to build vendor specific application.

VDS architecture 200 does not provide all the solutions for managing SANs because it provides complex tools to manage storage area networks. For example, command line utility program 204 uses intricate sequences of commands to create, configure and manage LUNs 206 in redundant array of inexpensive disks (“RAID”) storage subsystems and storage sub-system objects, for example, disks, partitions and volumes. Command line utility 204 also requires a user to select and configure each object and multiple steps are required to do the same, for example, one must select a provider, a subsystem and then a controller/adapter. For managing multiple servers tedious steps are required, which is not commercially desirable.

Besides VDS 201, conventional systems use languages like “Array” and “RAID” to allocate storage pool for a given server and to make it available for an application. The process requires at least three steps:

An Array Configuration Utility is run to create a LUN;

To associate a LUN to a given server a HBA's World Wide Port Name(s) (“WWPN”) is required and manually entered; and

To load the disk volume into the operating system, one has to run a utility like “Disk Manager 202” to allocate a drive letter and then the drive is formatted.

To make matters worse, different hardware vendors provide their own Array configuration utility that has different terminology and each operating system has different needs. Hence, the foregoing conventional solutions are tedious and make SAN configuration and management very difficult.

Therefore, there is a need for a system that provides a user-friendly interface to manage storage area networks.

### SUMMARY OF THE INVENTION

In one aspect of the present invention, a method for creating a logical unit number (“LUN”) in a storage area network is provided. The method includes selecting a storage sub-system from a list of available storage sub-subsystems for which the LUN is created in a wizard like setting, wherein a display attribute may be used for depicting connectivity of the storage sub-system to a server and/or host bus adapter; configuring the LUN for the selected storage sub-system; and assigning the LUN to at least one server.

In yet another application, a management application for creating a logical unit number (“LUN”) in a storage area network is provided. The application includes, computer executable code for selecting a storage sub-system from a list of available storage sub-subsystems for which the LUN is created, wherein a display attribute may be used for depicting connectivity of the storage sub-system to a server and/or host bus adapter; configuring the LUN for the selected storage sub-system; and assigning the LUN to at least one server.

A system for creating a logical unit number (“LUN”) in a storage area network is provided. The system includes a management application that includes computer executable code for selecting a storage sub-system from a list of available storage sub-subsystems for which the LUN is created, wherein a display attribute may be used for depicting connectivity of the storage sub-system to a server and/or host bus adapter; configuring the LUN for the selected storage sub-system; and assigning the LUN to at least one server.

In yet another aspect, a graphical user-interface (GUI) for creating a logical unit number (“LUN”) in a storage area network is provided. The GUI includes a utility in a wizard like setting for selecting a storage sub-system from a list of available storage sub-subsystems for which the LUN is created wherein a display attribute may be used for depicting connectivity of the storage sub-system to a server and/or host bus adapter; configuring the LUN for the selected storage sub-system; and assigning the LUN to at least one server.

In yet another aspect, a method for operating on a logical unit number (“LUN”) in a storage area network is provided. The method includes, extending an existing LUN by using a graphical user interface and selecting the LUN associated with a storage sub-system and a server and providing a size for extending the LUN.

The method also includes, shrinking an existing LUN by using a graphical user interface and selecting the LUN associated with a storage sub-system and a server and providing a size for shrinking the LUN.

The method further includes, deleting an existing LUN by using a graphical user interface and selecting the LUN associated with a storage sub-system and a server.

In yet another aspect, the method includes, partitioning a LUN in a wizard like setting by assigning a partition size, and drive letter.

This brief summary has been provided so that the nature of the invention may be understood quickly. A more complete understanding of the invention can be obtained by reference to the following detailed description of the preferred embodiments thereof concerning the attached drawings.

### BRIEF DESCRIPTION OF THE DRAWINGS

The foregoing features and other features of the present invention will now be described with reference to the drawings of a preferred embodiment. In the drawings, the same components have the same reference numerals. The illustrated embodiment is intended to illustrate, but not to limit the invention. The drawings include the following Figures:

FIG. 1A shows a SAN with an adapter, used according to one aspect of the present invention;

FIG. 1B shows a top-level diagram of a SAN;

FIG. 1C shows the internal architecture of a host system, used according to one aspect of the present invention;

FIG. 2 shows a block diagram of a VDS system, used according to one aspect of the present invention;

FIG. 3 is a flow diagram for managing storage area networks, according to one aspect of the present invention; and

FIGS. 4-25 show screen shots of a VDS Manager, according to one aspect of the present invention.

### DETAILED DESCRIPTION OF THE PREFERRED EMBODIMENTS

To facilitate an understanding of the preferred embodiment, the general architecture and operation of a system using storage devices will be described. The specific architecture and operation of the preferred embodiment will then be described with reference to the general architecture.

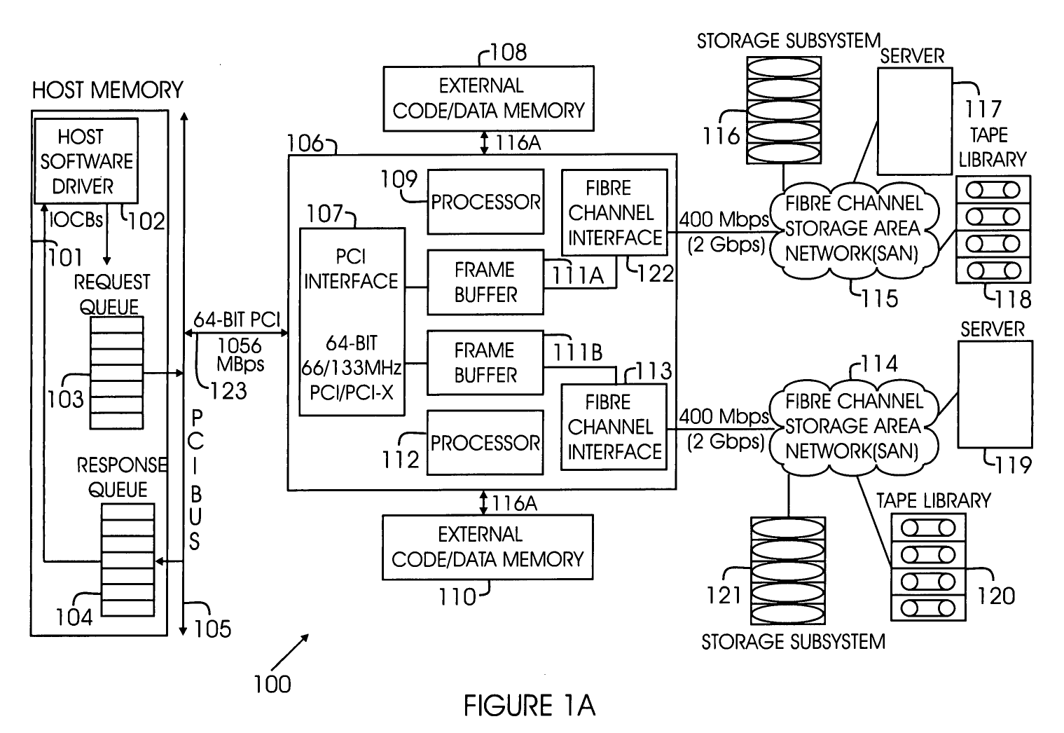

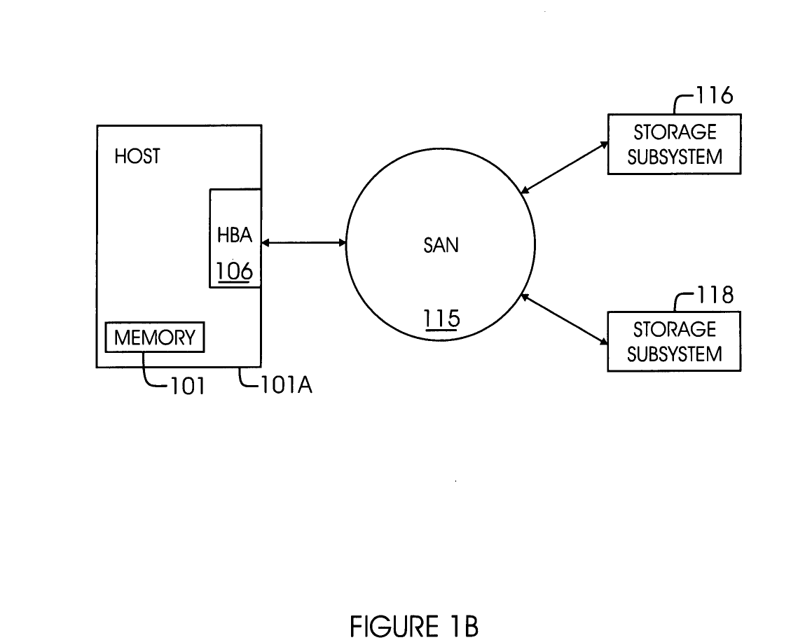

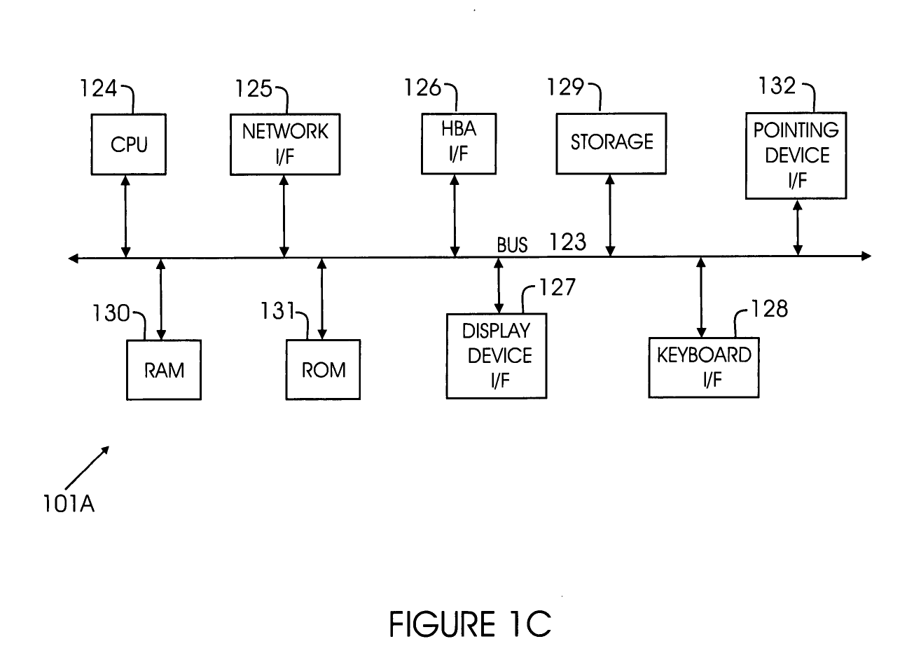

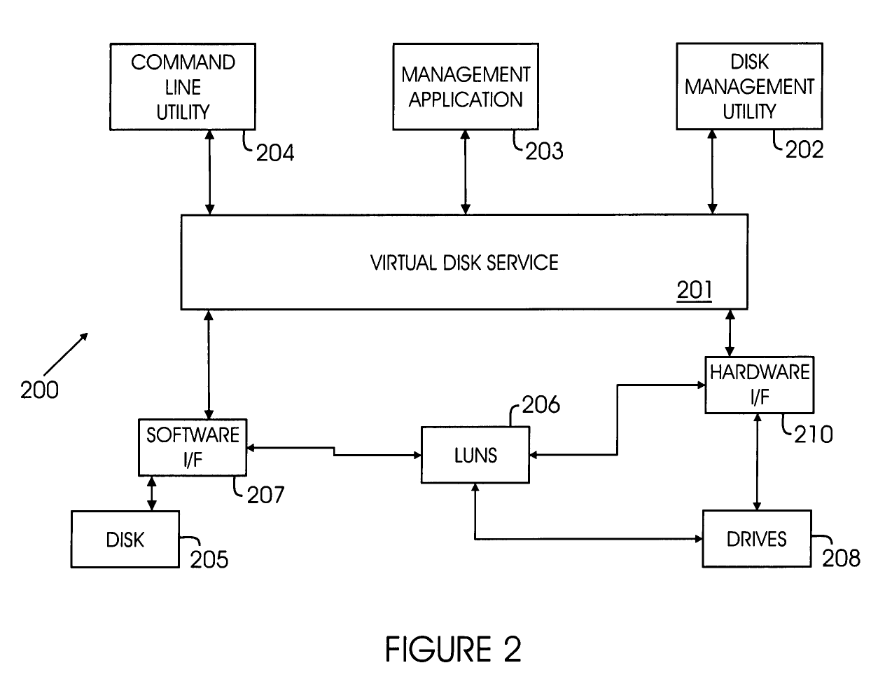

FIG. 1B shows a host system 101A with memory 101 coupled to a SAN 115 that is coupled to storage subsystem 116 and 118. It is noteworthy that a host system 101A, as referred to herein, may include a computer, server or other similar devices, which may be coupled to storage systems. Host system 101A includes a host processor, random access memory (“RAM”), and read only memory (“ROM”), and other components to communicate with various SAN modules, as described below.

FIG. 1A shows a system 100 that uses a controller/adapter 106 (referred to as “adapter” 106) for communication between a host system (not shown) with host memory 101 to various storage systems (for example, storage subsystem 116 and 121, tape library 118 and 120) using fibre channel storage area networks 114 and 115.

Host system 101A communicates with adapter 106 via a PCI bus (or PCI-X) 123 through a PCI (or PCI-X) interface 107. Adapter 106 includes processors 112 and 109 for the receive and transmit side, respectively. Processor 109 and 112 may be a RISC processor.

Host memory 101 includes a driver 102 that uses a request queue 103 and response queue 104 to communicate with various storage sub-systems.

Transmit path in this context means data path from host memory 101 to the storage systems via adapter 106. Receive path means data path from storage subsystem to the host via adapter 106. It is noteworthy, that although one processor is shown for each of the receive and transmit paths, the present invention is not limited to any particular number/type of processors.

Adapter 106 also includes fibre channel interface (also referred to as fibre channel protocol manager “FPM”) 122 and 113 in receive and transmit paths, respectively. FPM 122 and 113 allow data to move to/from storage systems 116, 118, 120 and 121.

Adapter 106 includes external memory 108 and 110 and frame buffers 111A and 111B that are used to move information to and from the host to other SAN components via 116A.

FIG. 1C is a block diagram showing the internal functional architecture of host system 101A. As shown in FIG. 1C, host system 101A includes a microprocessor or central processing unit (“CPU”) 124 that interfaces with a computer bus 123 for executing computer-executable process steps. Also shown in FIG. 1C are a network interface 125 that provides a network connection, and an adapter interface 126 that interfaces host system 101A with adapter 106. It is noteworthy that interface 125 and 126 may be a part of adapter 106 and the present invention is not limited to any particular type of network or adapter interface.

Host system 101A also includes a display device interface 127, a keyboard interface 128, a pointing device interface 132, and a storage device 129 (for example, a disk, CD-ROM or any other device).

Storage 129 may store operating system program files, application program files (management application 203, according to one aspect of the present invention), and other files. Some of these files are stored on storage 129 using an installation program. For example, CPU 124 executes computer-executable process steps of an installation program so that CPU 124 can properly execute the application program.

A random access main memory (“RAM”) 130 also interfaces with computer bus 123 to provide CPU 124 with access to memory storage. When executing stored computer-executable process steps from storage 129, CPU 124 stores and executes the process steps out of RAM 130.

Read only memory (“ROM”) 131 is provided to store invariant instruction sequences such as start-up instruction sequences or basic input/output operating system (BIOS) sequences for operation of a keyboard (not shown).

In one aspect of the present invention, VDS architecture 200 and the storage network industry association (“SNIA”) initiative “SMS-S” is used to provide a graphical user interface for efficiently managing storage area networks via management application 203. SMS-S specification, incorporated herein by reference in its entirety, provides a common interface for implementing management functionality. A single wizard is provided, which allows a user to select an array from a list of arrays, to allocate new storage pool. An array in this context means a layout of more than one disk storage devices, for example, in a RAID configuration.

It is noteworthy that the adaptive aspects of the present invention described herein are not limited to VDS architecture 200 or any industry standard.

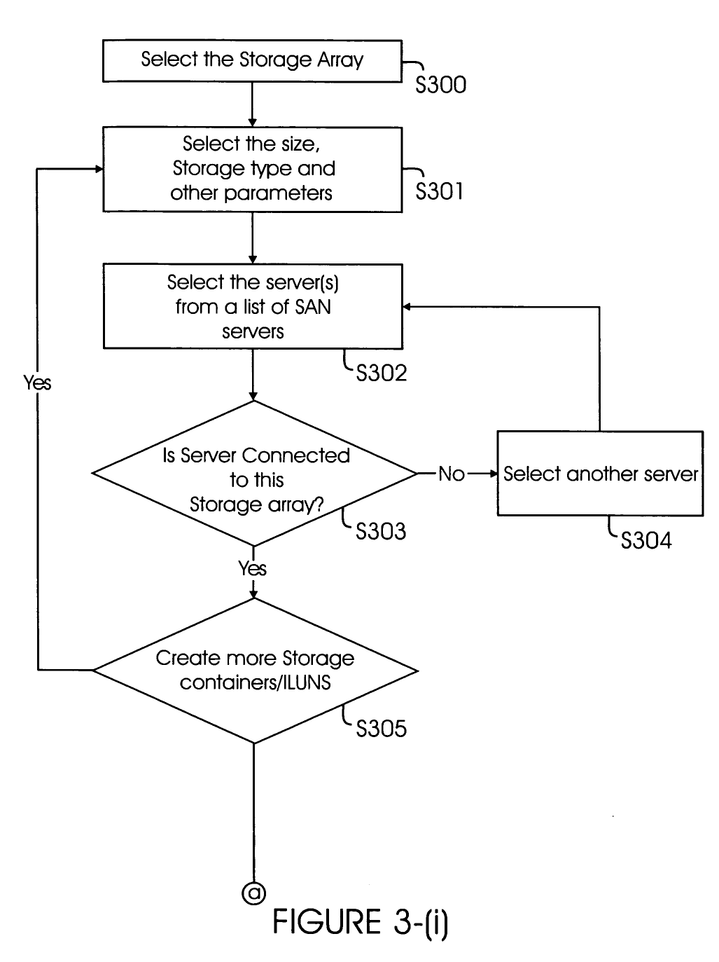

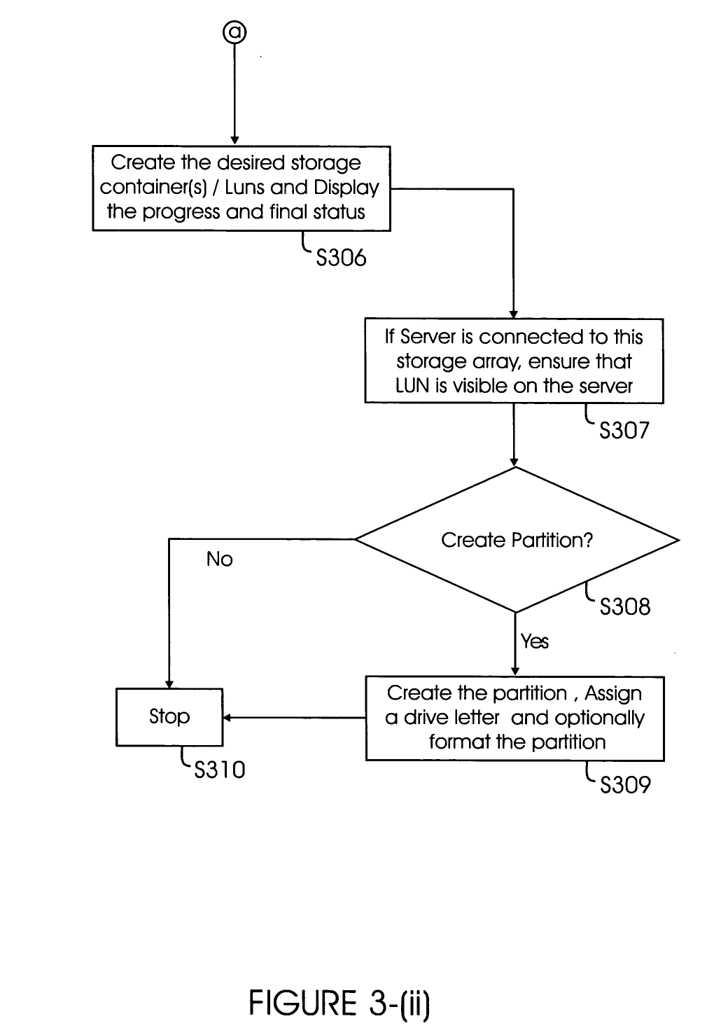

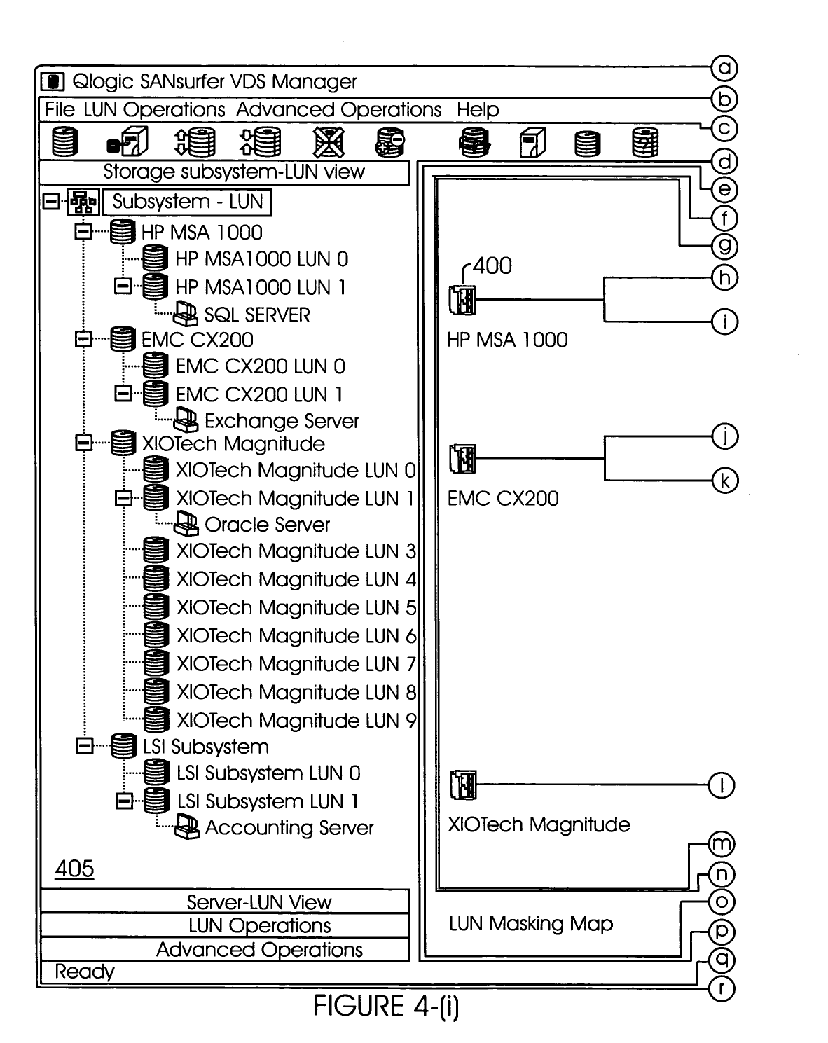

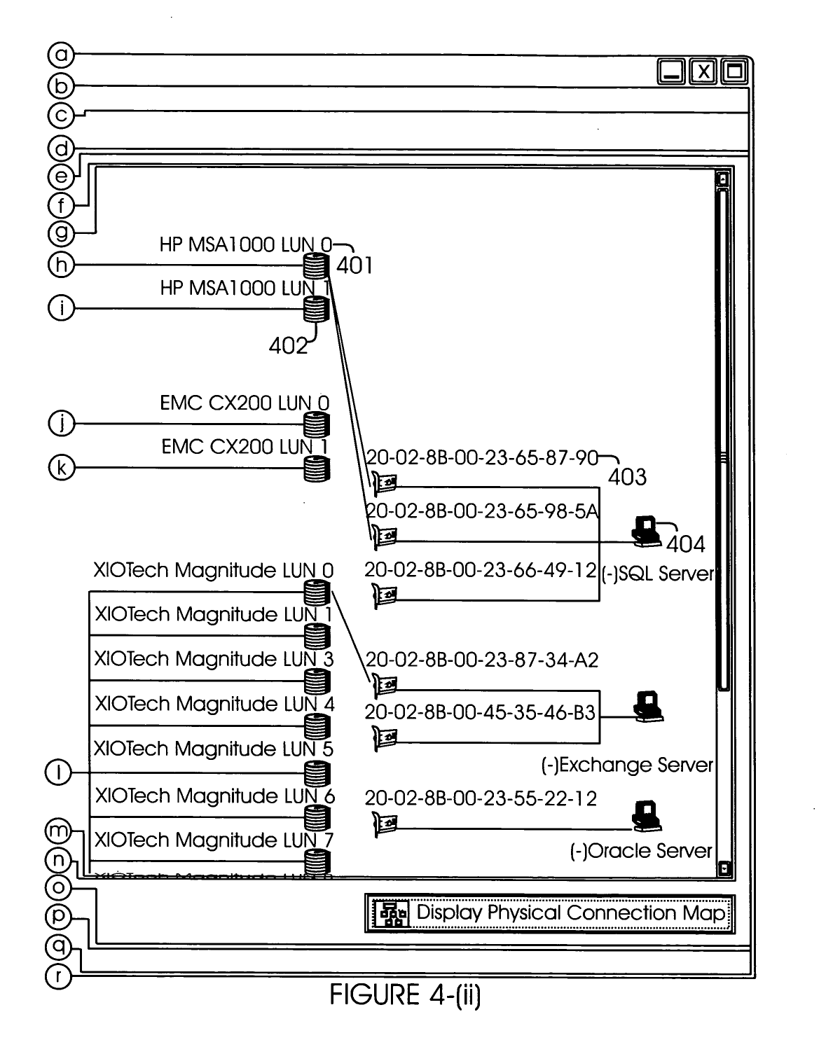

FIG. 3 shows a process flow diagram for automatically creating LUNs and allocating storage, according to one aspect of the present invention. In step S300, a storage array is selected (for example, subsystem 116). In step S301, the size and storage type is selected. This is performed in a wizard like setting, as described below with respect to FIGS. 4-25.

In step S302, a server is selected from a list of SAN servers. In step S303, the process determines if the server selected in step S302 is operationally coupled to the storage array. If it is not, then in step S304, the process selects another server. If the server is coupled to the storage array, then in step S305, the process determines if it should create more LUNs (or storage containers). If yes, then in step S306, the process creates LUNS and displays the progress and final status of creating the LUNs/storage containers.

After the LUNs are created, in step S307, the process ensures that the LUN is now visible on the selected server.

In step S308, the process determines if a partition needs to be created for the LUN. If yes, then the partition is created and a drive letter is assigned. Thereafter, the process ends in step S309.

In one aspect of the present invention, a wizard like utility is provided to create LUNS that allows a user to easily manage a SAN. Also, a user does not has to manually enter all LUN information.

FIGS. 4-25 show screen shots of various adaptive aspects of the present invention for creating/extending/shrinking/mounting a LUN according to one aspect of the present invention. A wizard like utility is provided such that overall SAN management is simplified. The wizard like utility may be run on a host system 101A or a similar computing system.

FIG. 4 shows a storage sub-system 400 LUN view. Storage sub-system 400 is shown to have LUNs 401 and 402 coupled to server 404 via HBA 403. Window 405 shows a tree like structure with various sub-systems. A user can click on any subsystem and view the various LUNs. Users can also view the server (for example, 404) and HBAs (for example, 403).

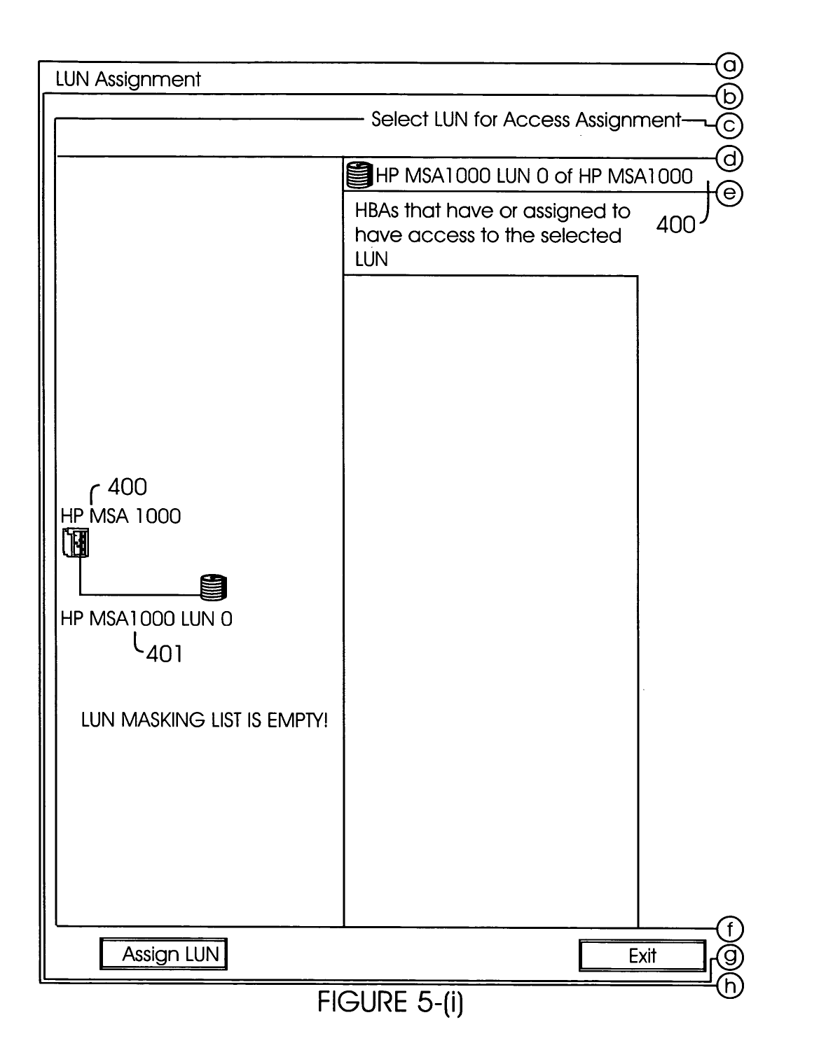

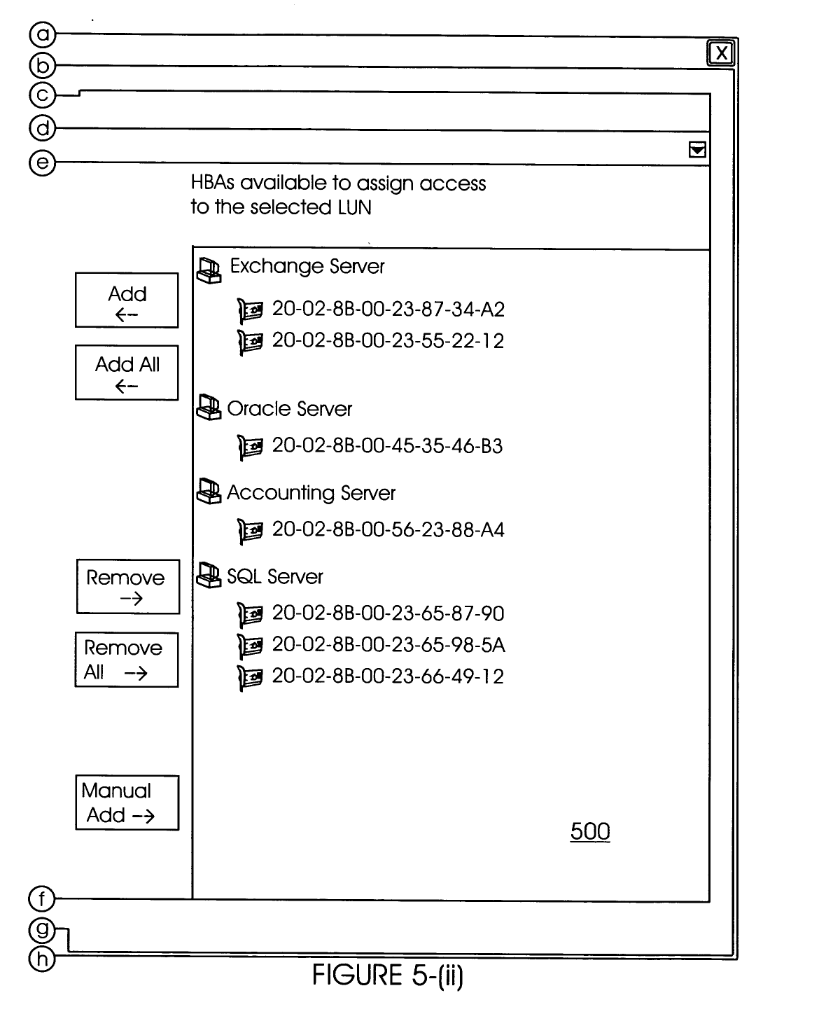

FIG. 5 shows a screen shot from the wizard like utility where subsystem 400 has LUN 401. The LUN masking list is empty in FIG. 5. A list of servers 500 is provided that can be used to perform LUN masking.

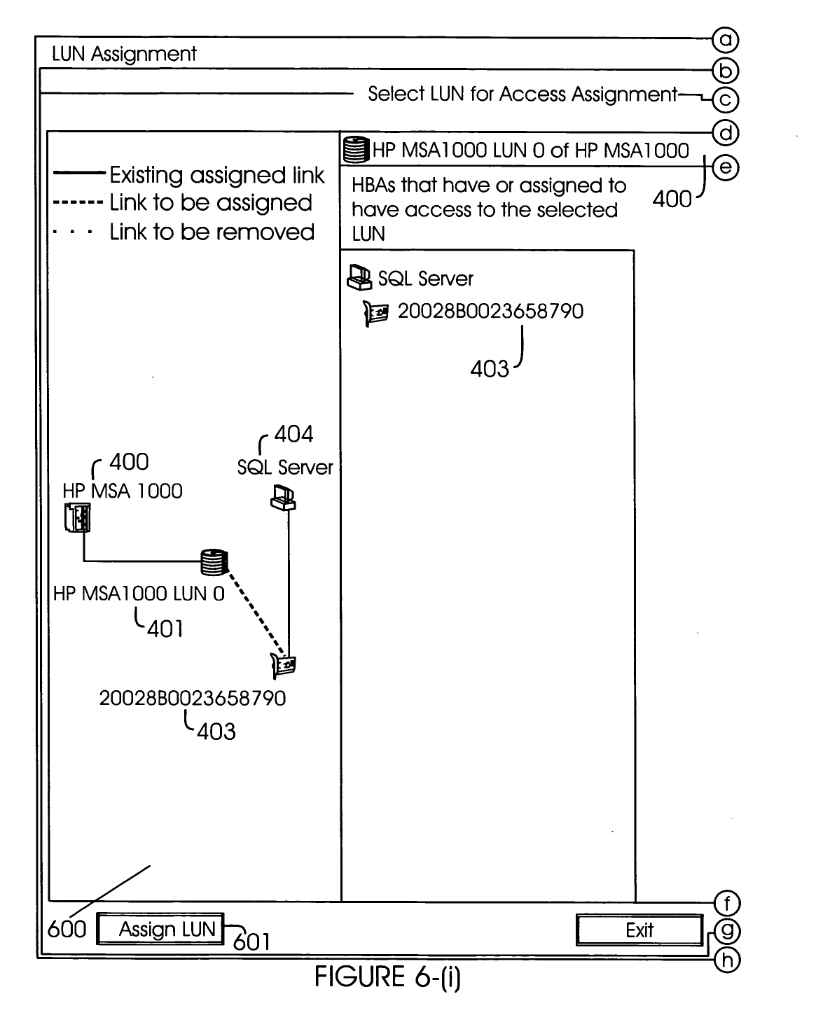

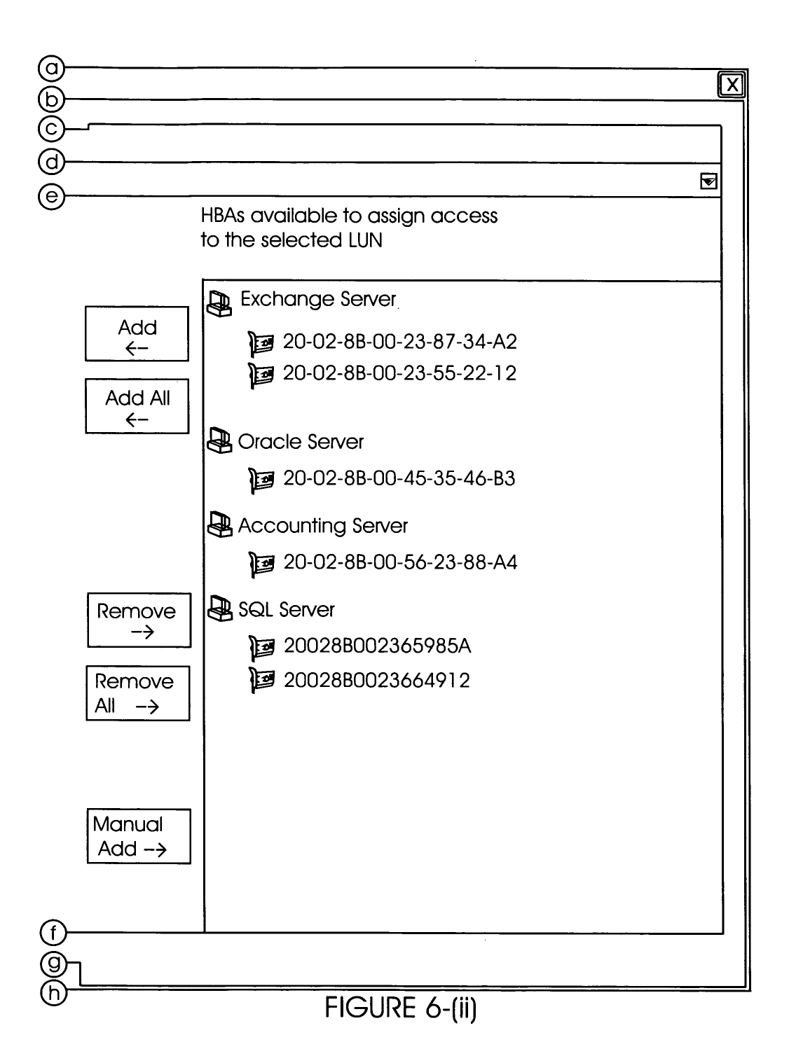

In FIG. 6, HBA 403 is assigned to LUN 401. A broken line in window 600 shows that the link needs to be assigned. A solid line represents an existing assigned link. The graphical illustration in window 600 shows that HBA 403 is coupled to LUN 401.

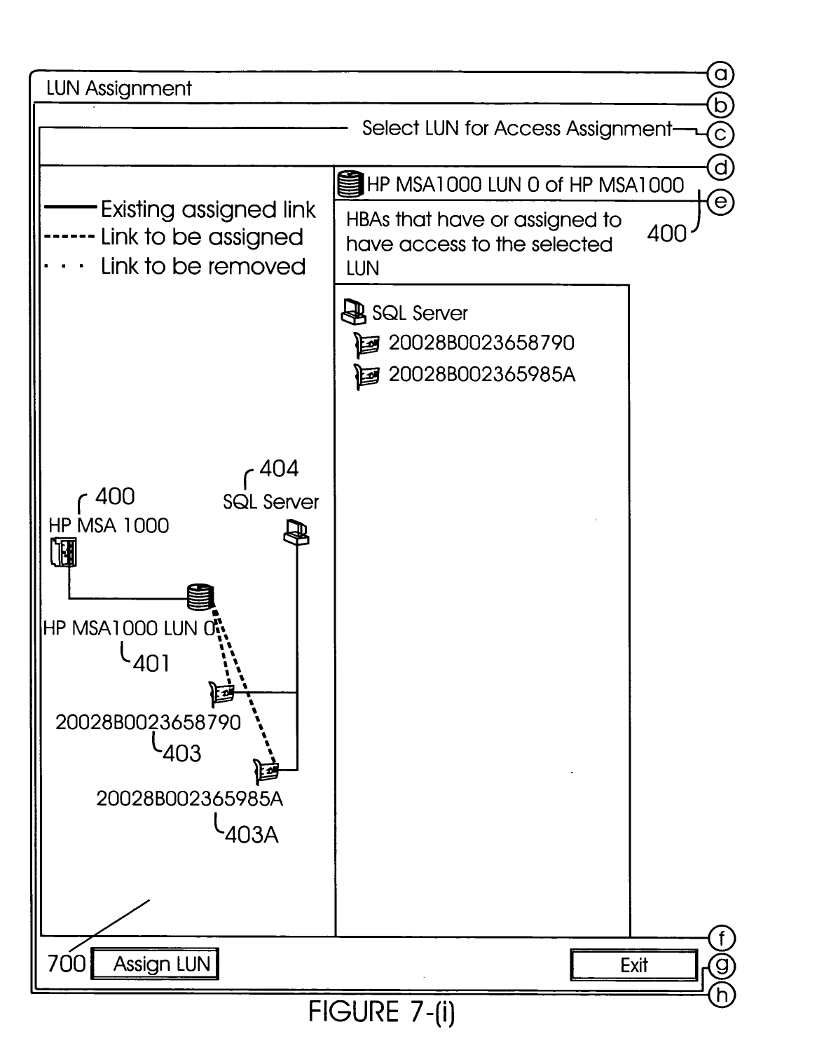

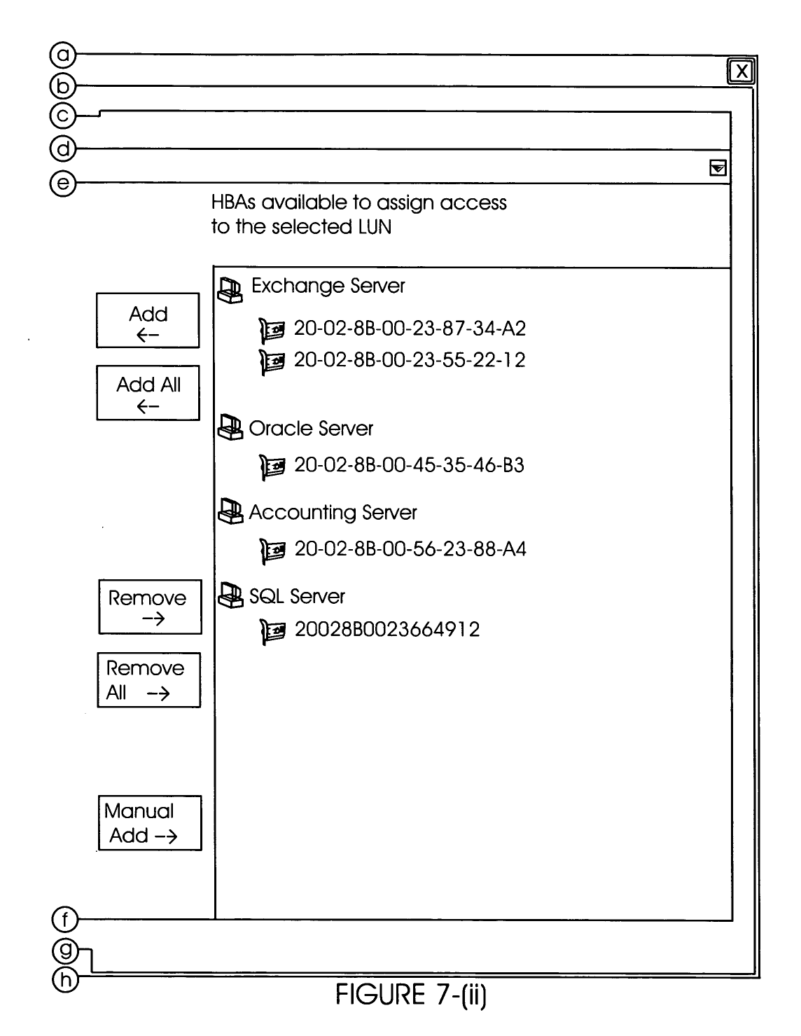

FIG. 7 shows window 700 with two HBAs 403 and 403A coupled to LUN 401. The wizard like utility allows a user to select one HBA at a time, or select an entire group.

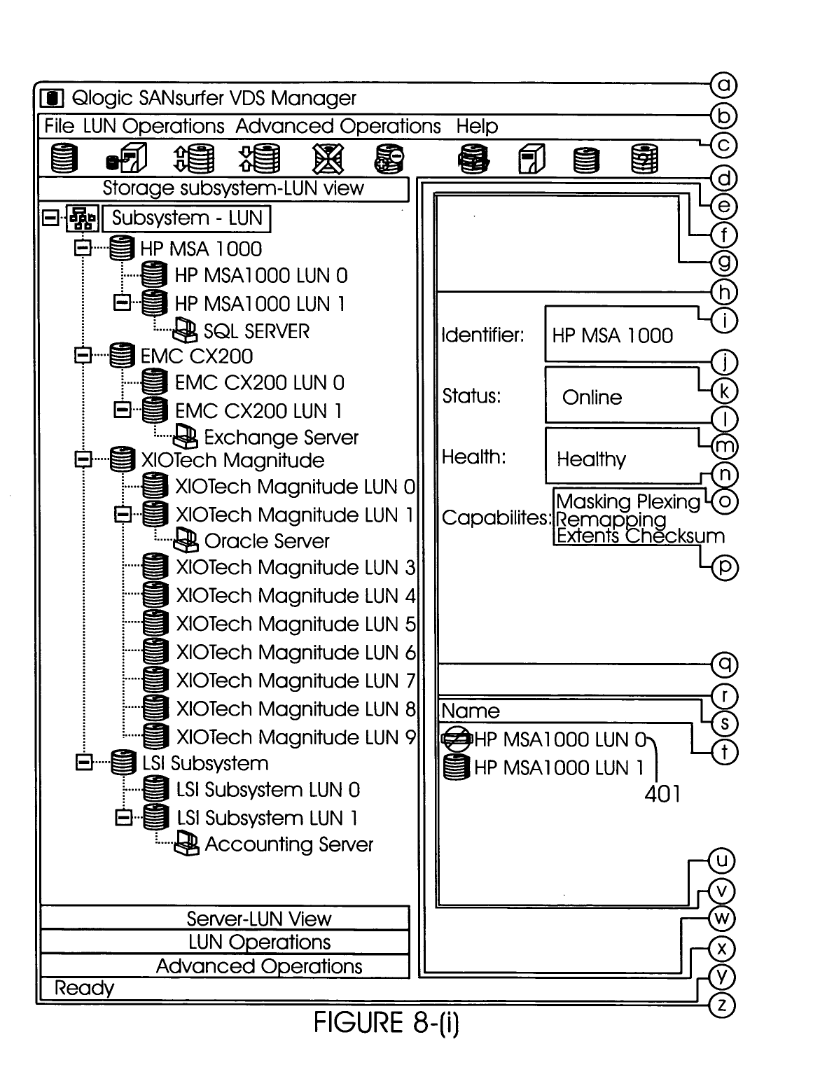

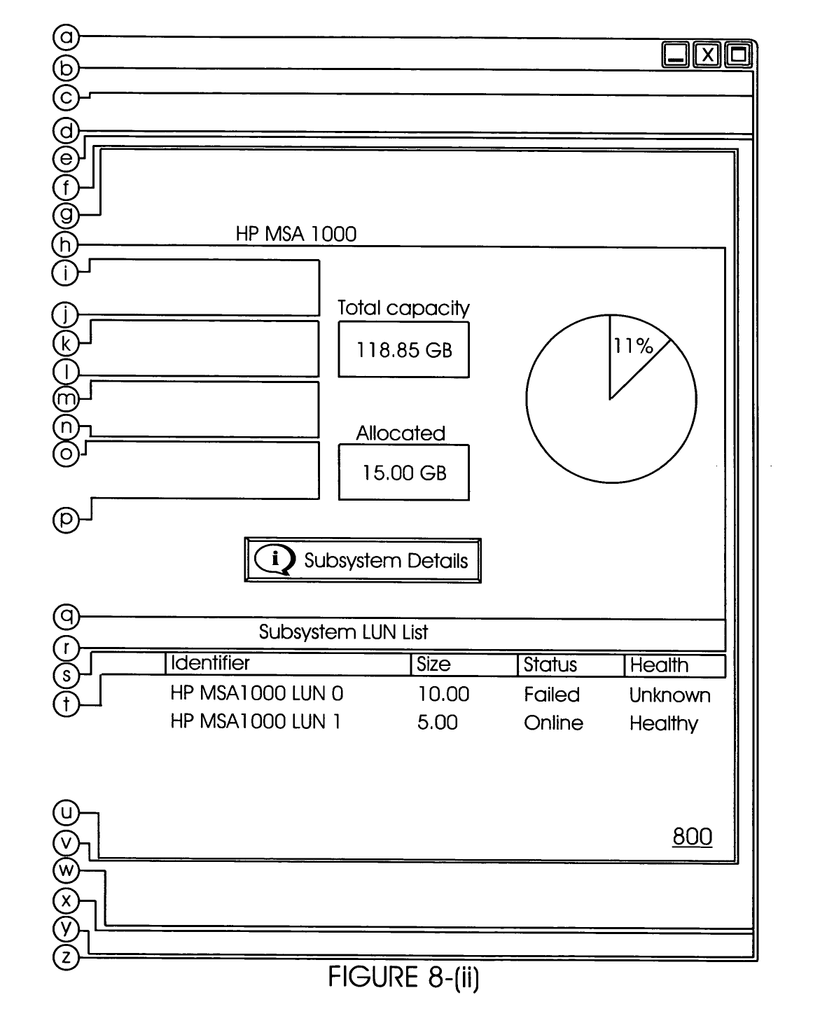

FIG. 8 shows a window 800 with a sub-system LUN list. The list shows LUN 401 and provides the status of the connection (i.e. “failed” or “online”).

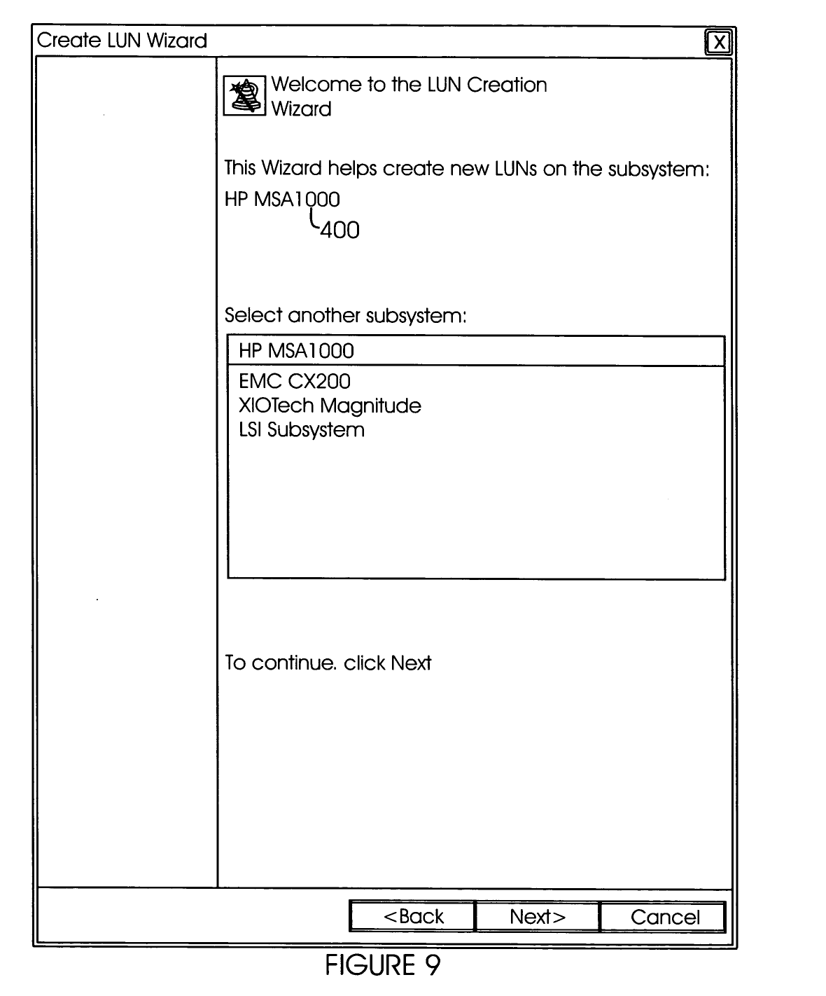

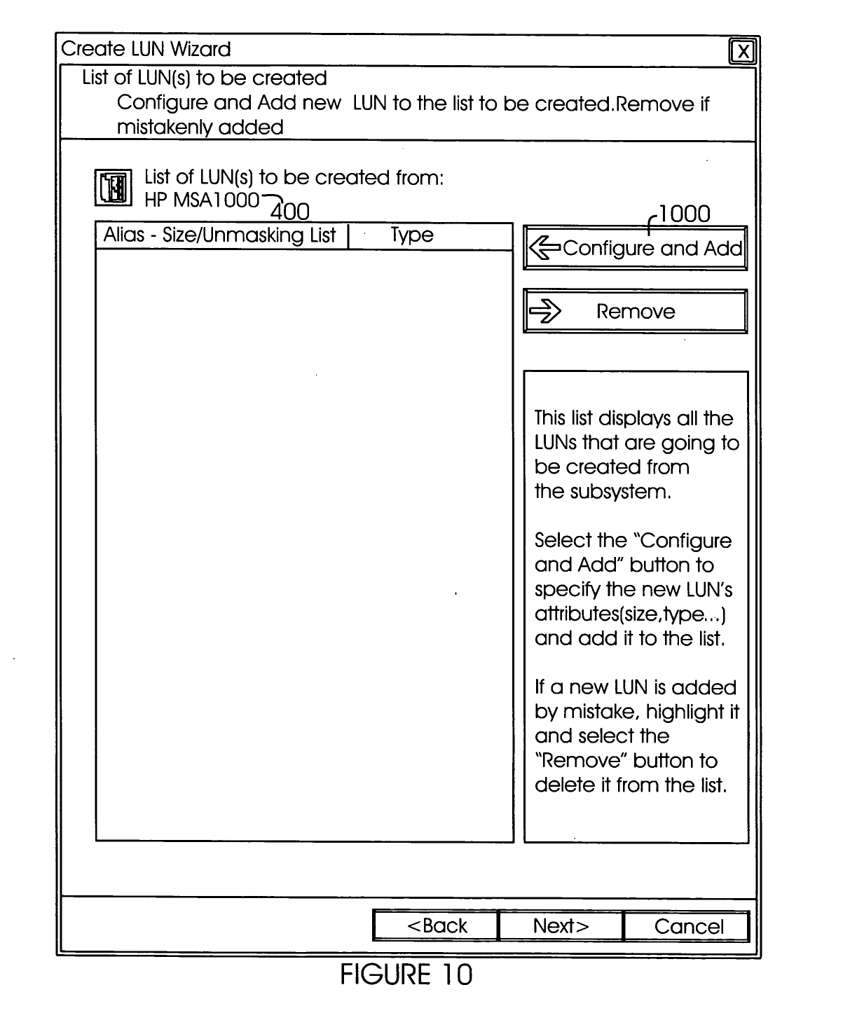

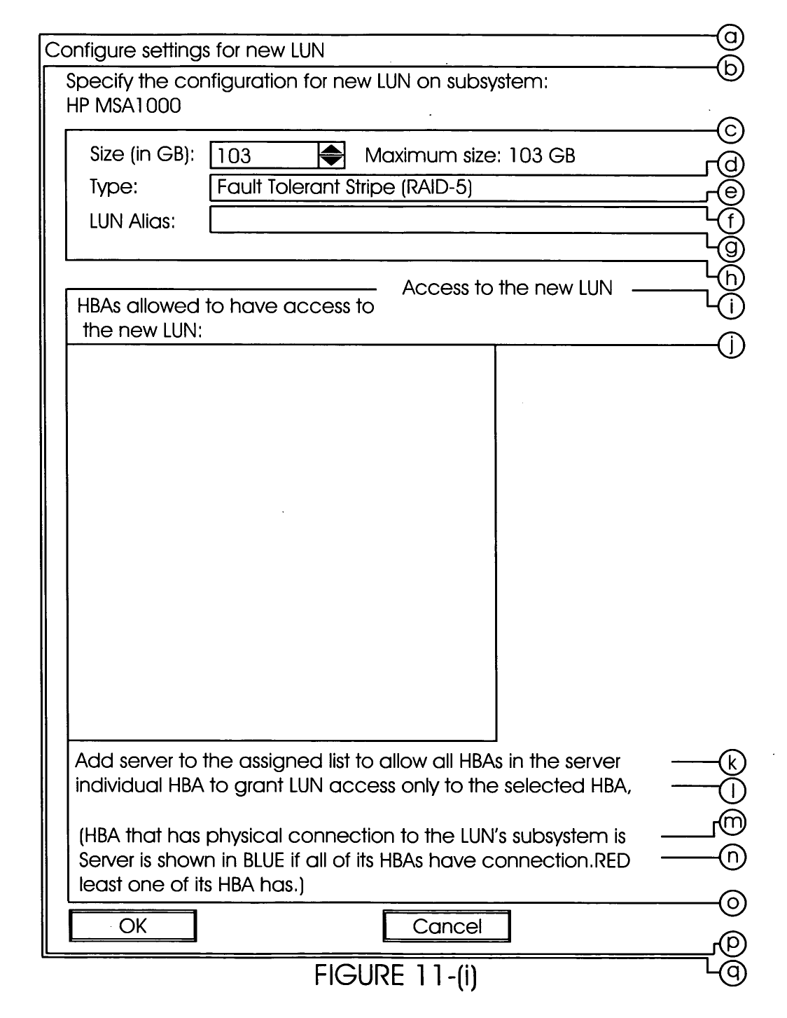

FIG. 9 shows an interface for creating a LUN, according to one aspect of the present invention. Sub-system 400 is selected and in FIG. 10, an interface is provided that allows a user to configure and add a LUN by clicking on button 1000.

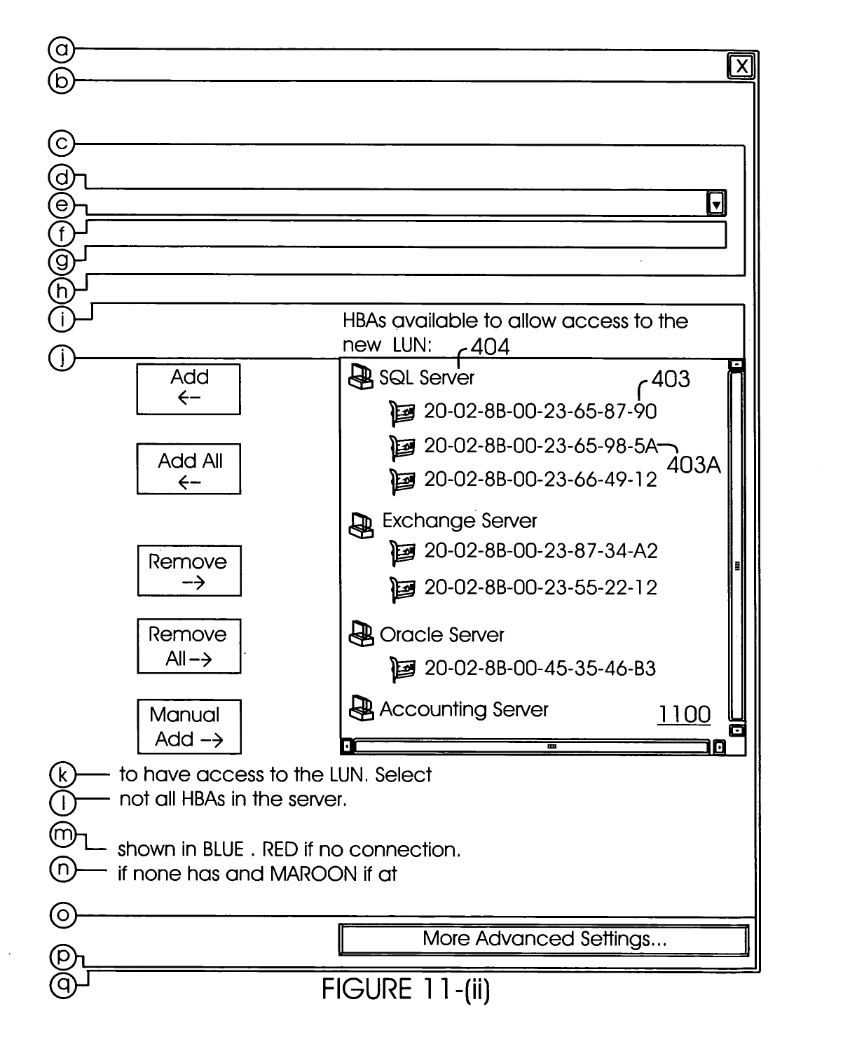

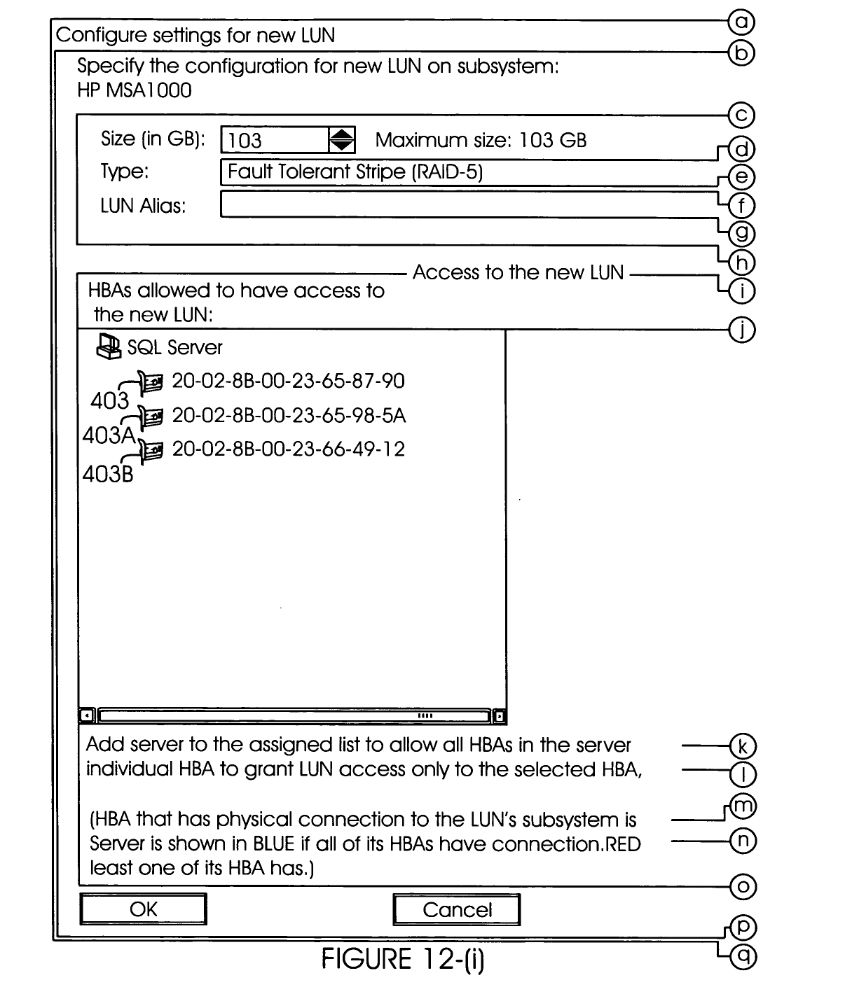

FIG. 11 provides a useful graphical user interface (“GUI”) that displays the various servers (for example, 404) in window 1100. An HBA's physical connection to the LUN's sub-system may be shown in different colors, for example, blue, and if there is no connection, it may be shown in red. It is noteworthy that any other color may be used in window 1100 to show connectivity between the servers and the HBAs.

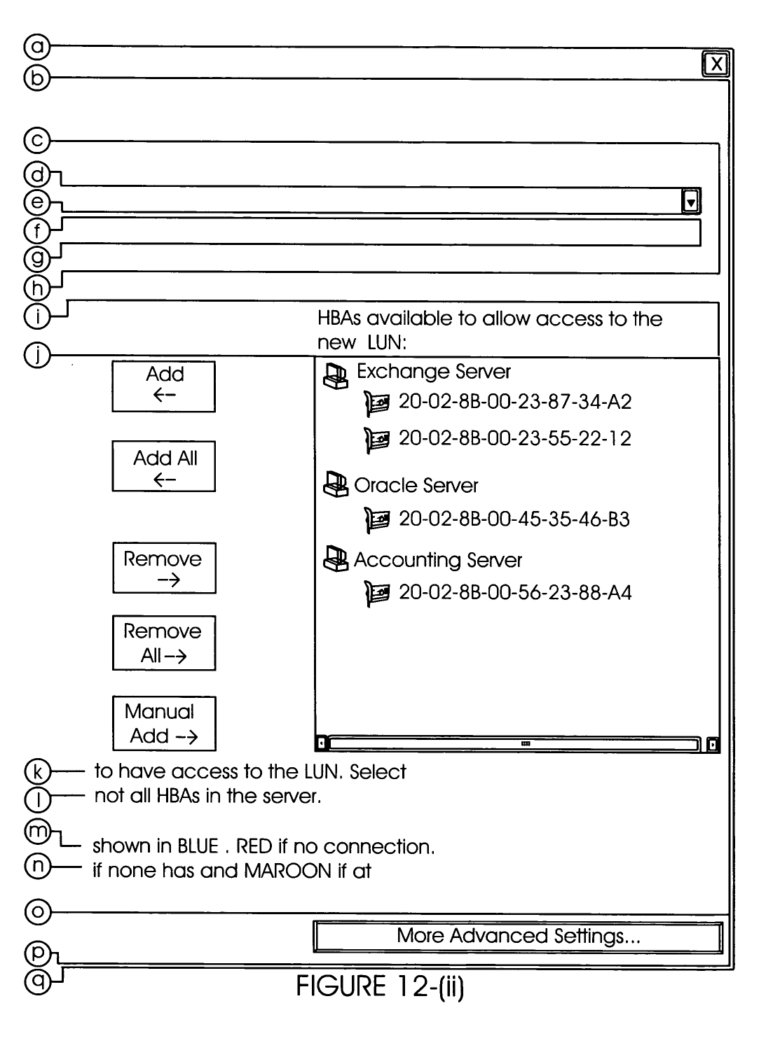

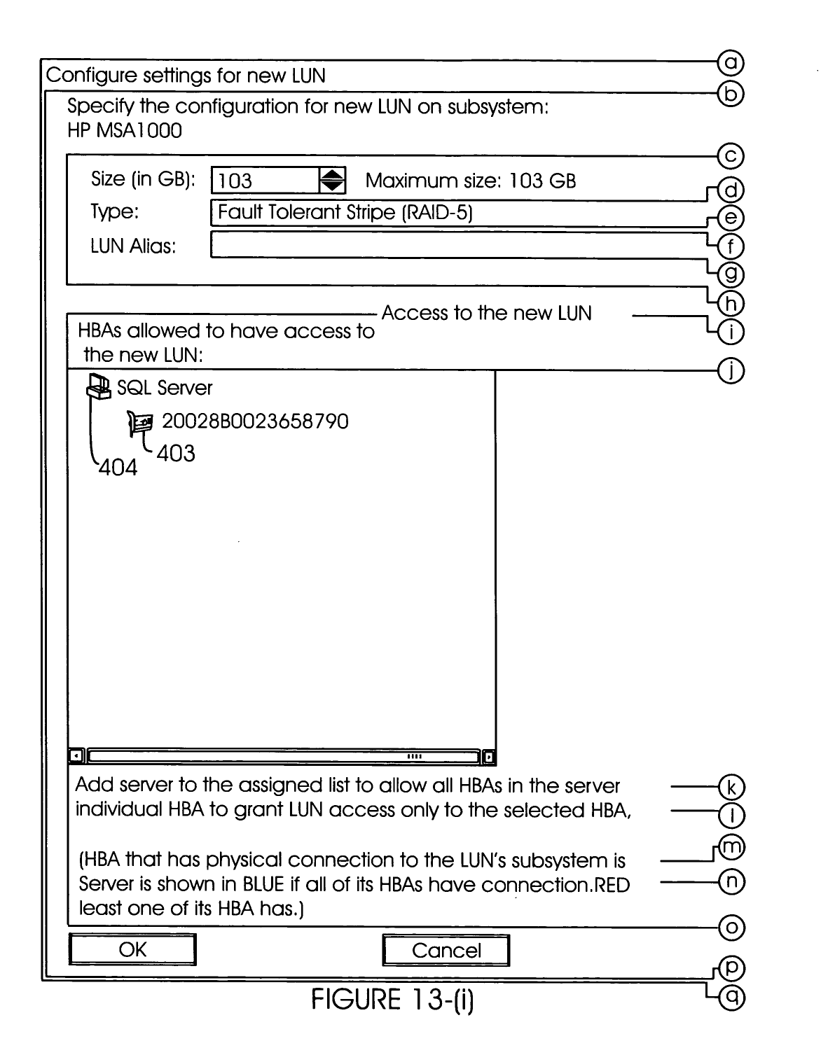

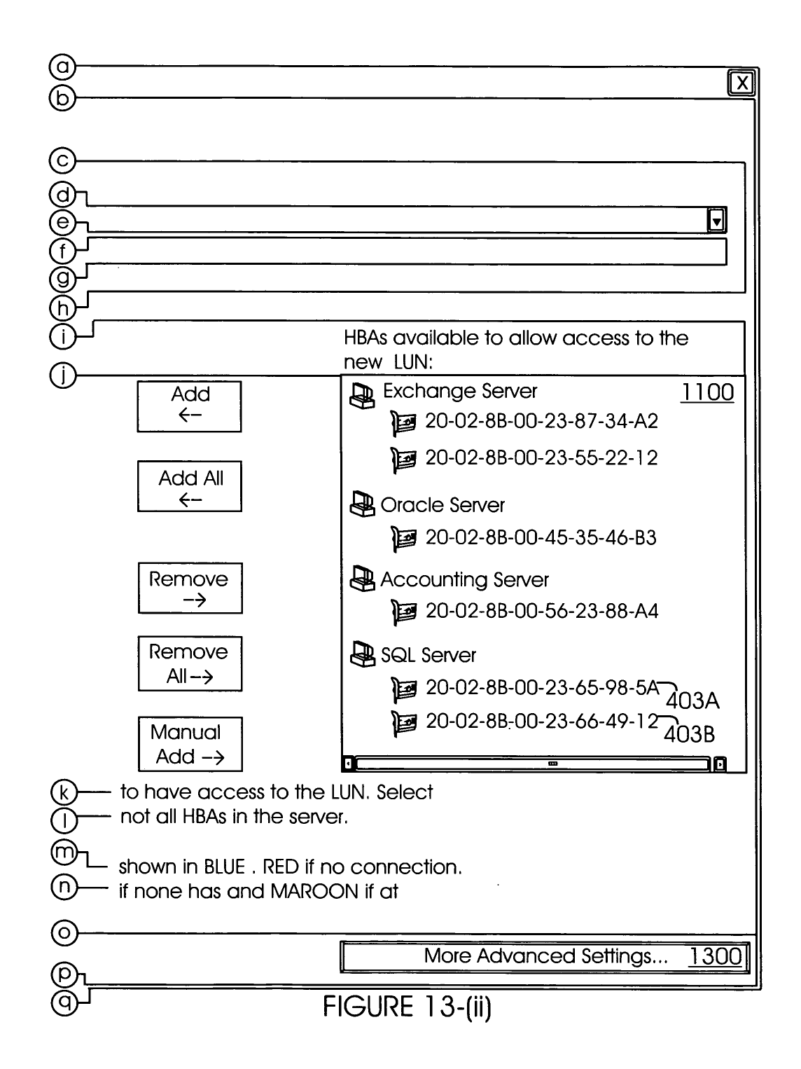

FIG. 12 shows how all the HBAs (403, 403A and 403B) under server 404 may be selected. It is noteworthy that the color scheme shows the user, which HBA is connected, and hence a user may choose to select only the connected HBA. This is shown in FIG. 13 where HBA 403 is connected and selected. HBAs 403A and 403B are not connected.

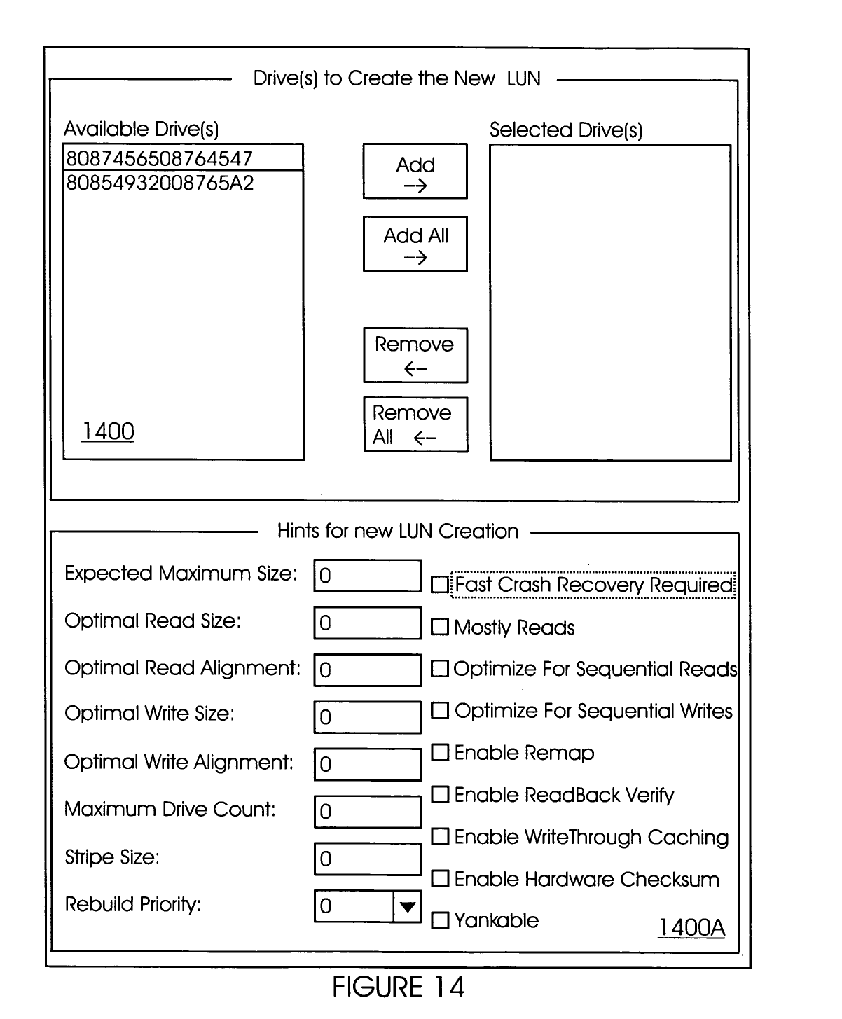

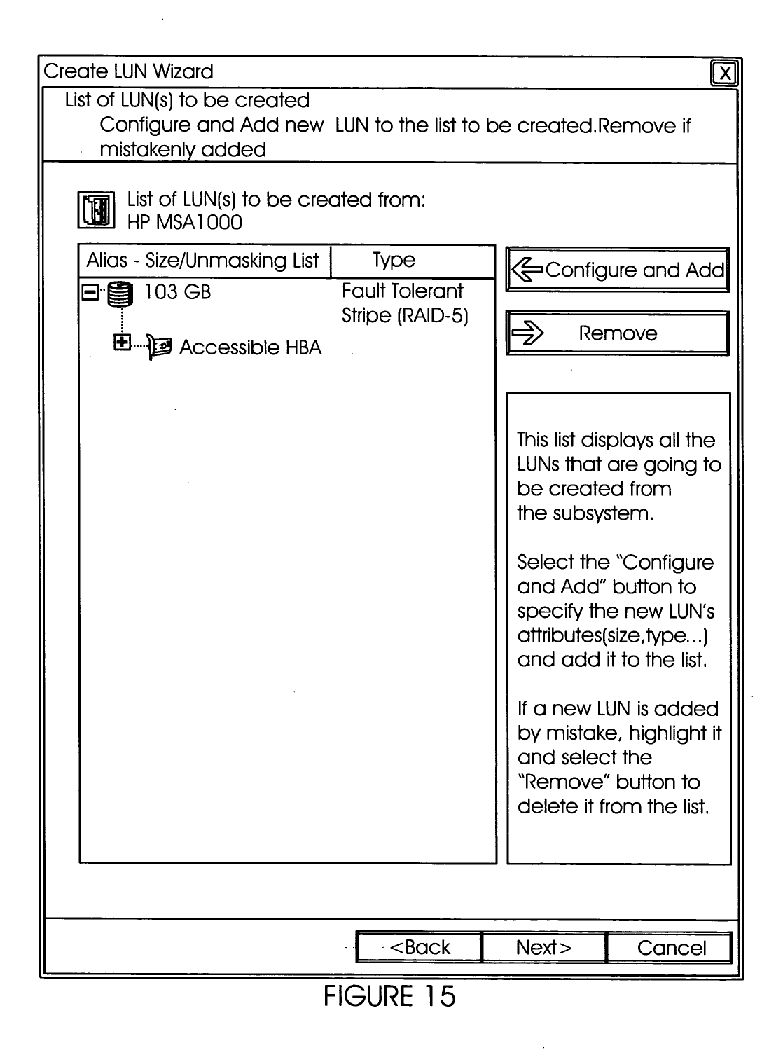

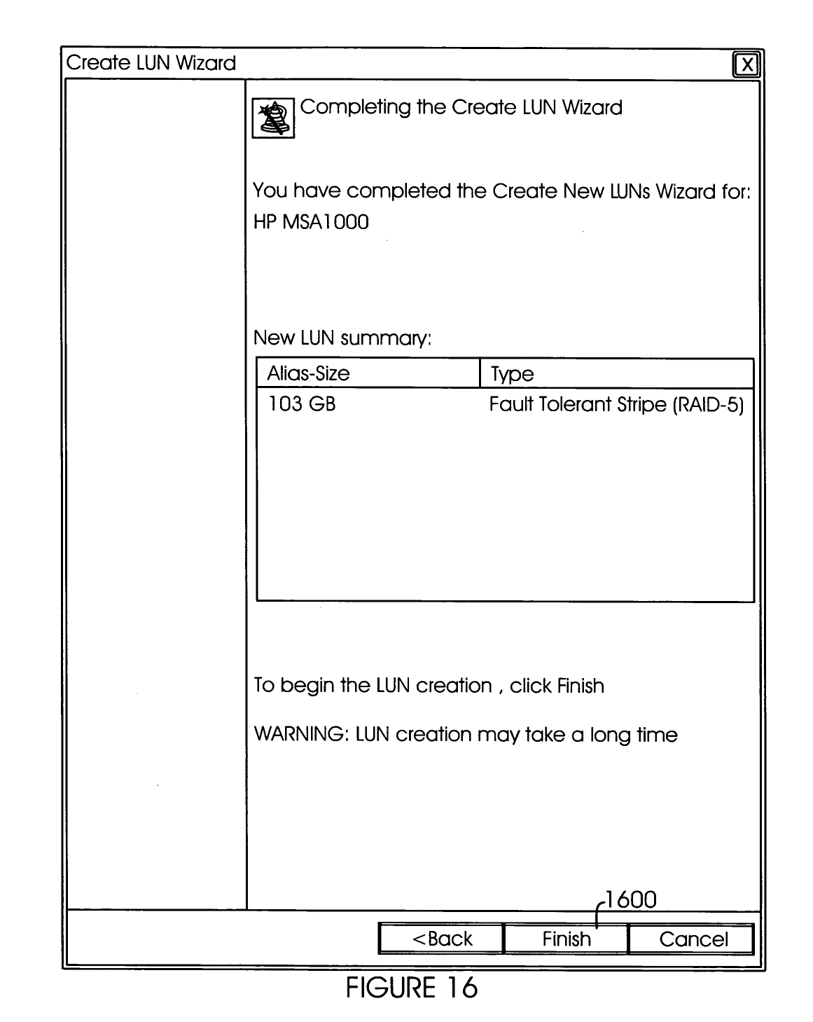

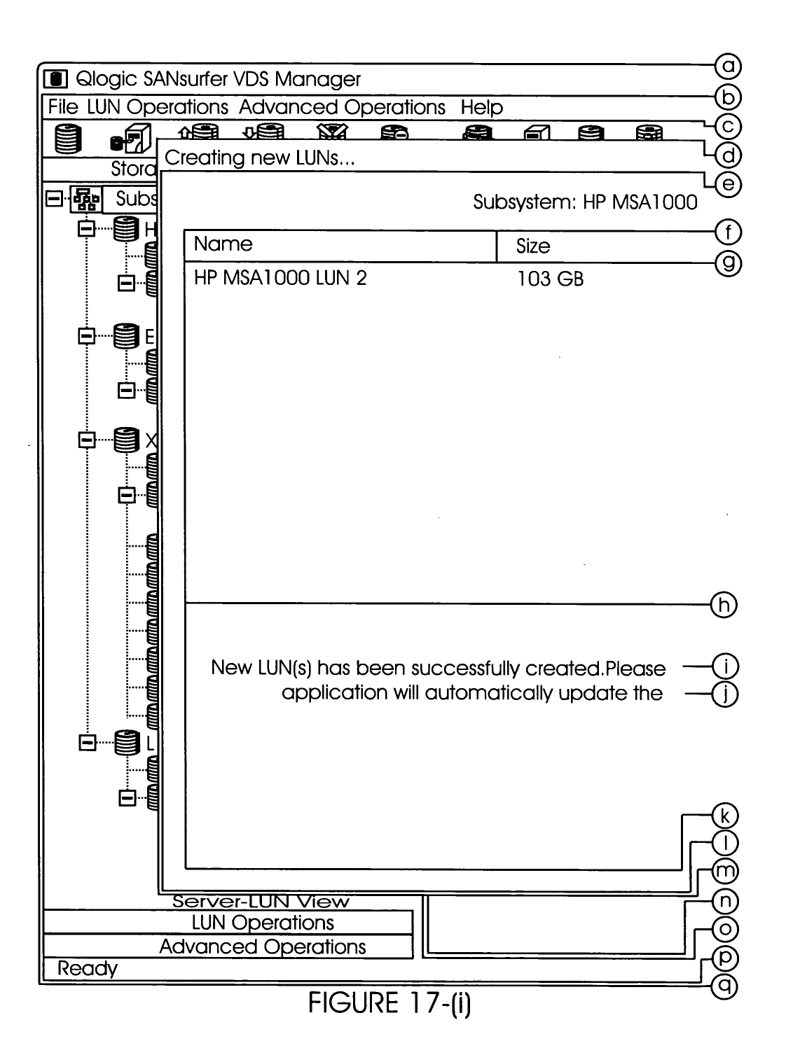

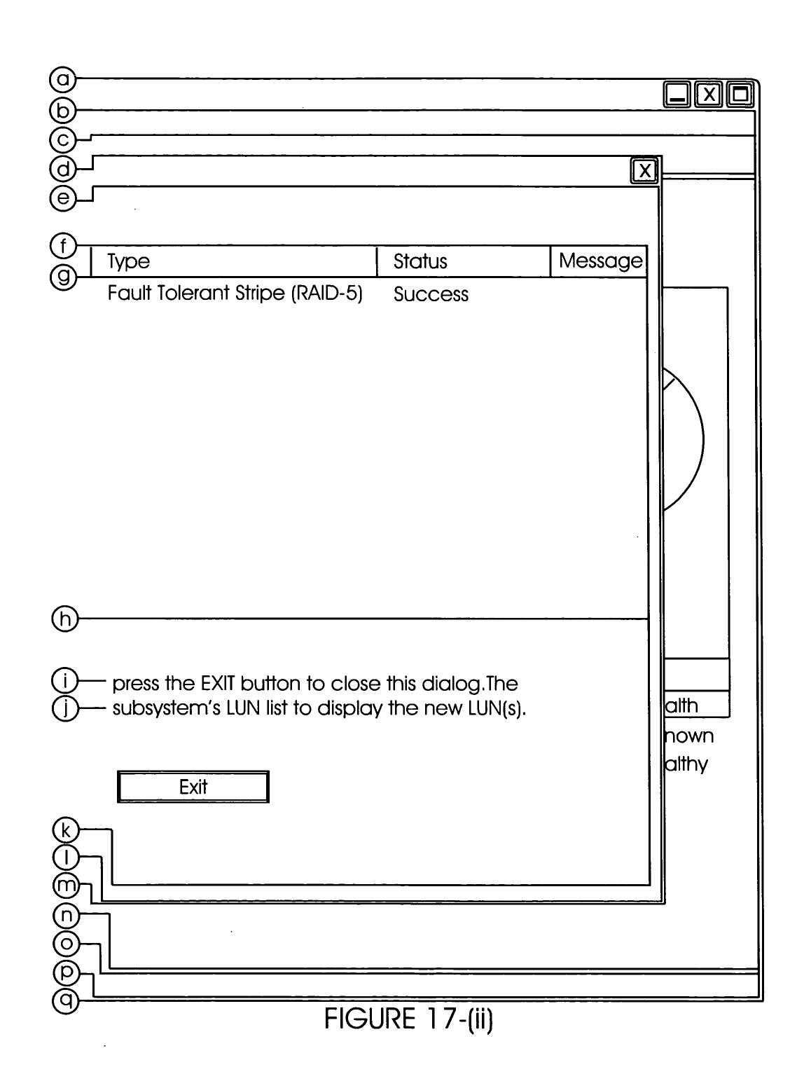

FIG. 14 shows an interface that is made available to a user after the user clicks on the “More Advanced Settings” button 1300 (FIG. 13). Window 1400 allows a user to select between drives and set various disk parameters shown in window 1400A. FIG. 15 shows a listing of the LUNs that is being created. By pressing the “Finish” button 1600 in FIG. 16, the LUN wizard is completed and a new LUN can be created. This is shown in FIG. 17.

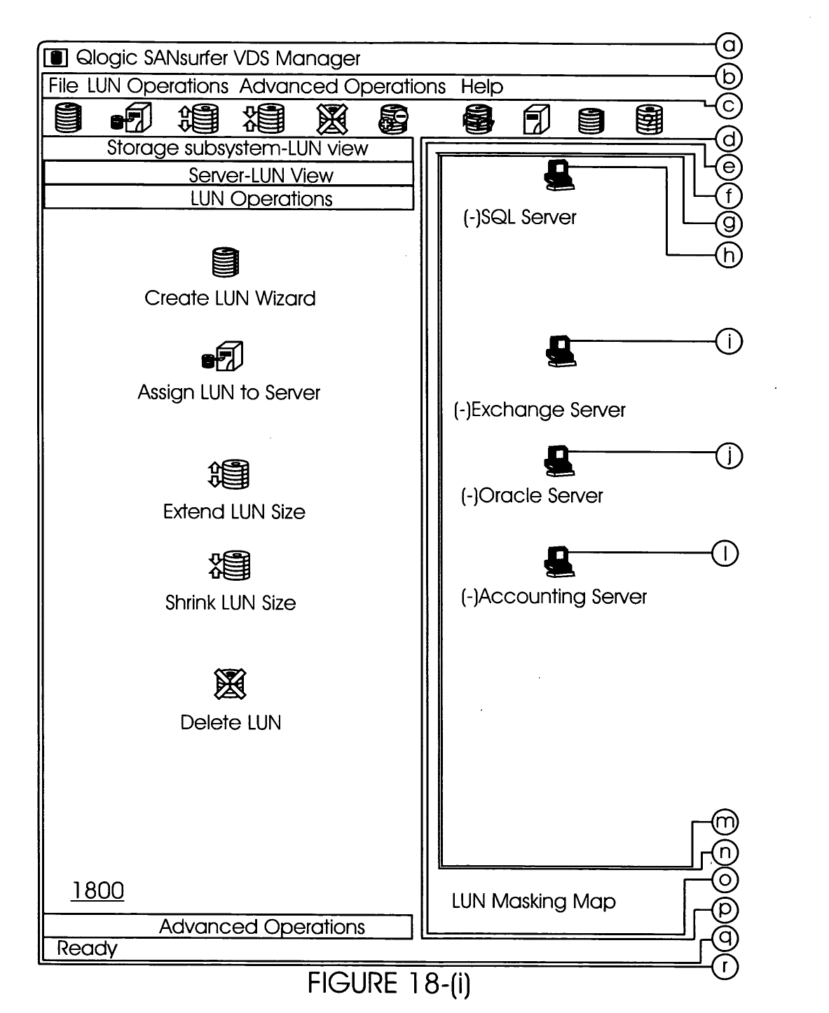

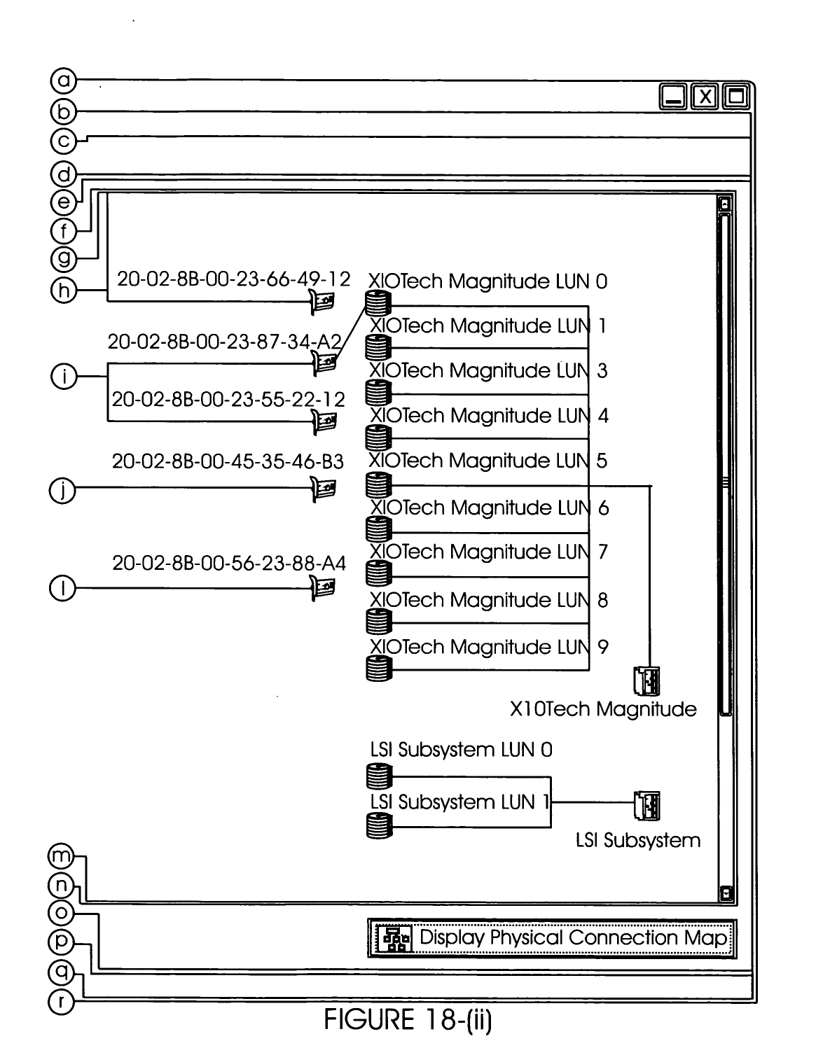

FIG. 18 shows an interface with window 1800 that provides various LUN related options, for example, creating a LUN wizard and assigning a LUN to a server (both described above), extending, shrinking and deleting a LUN.

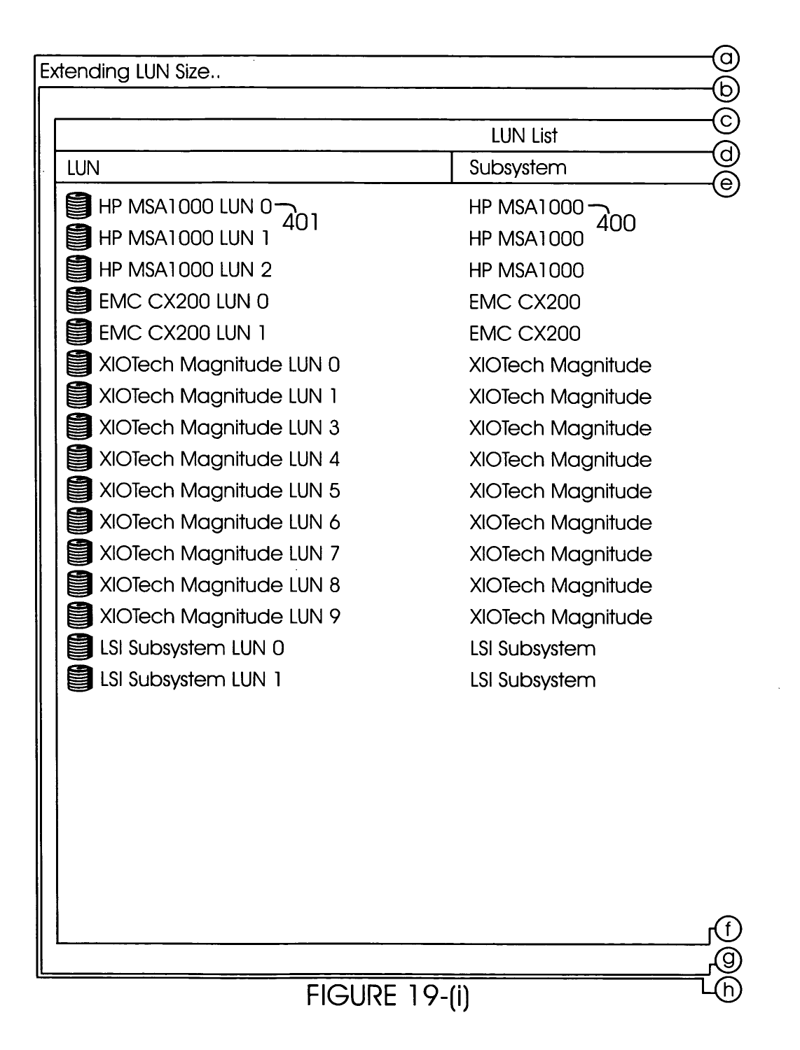

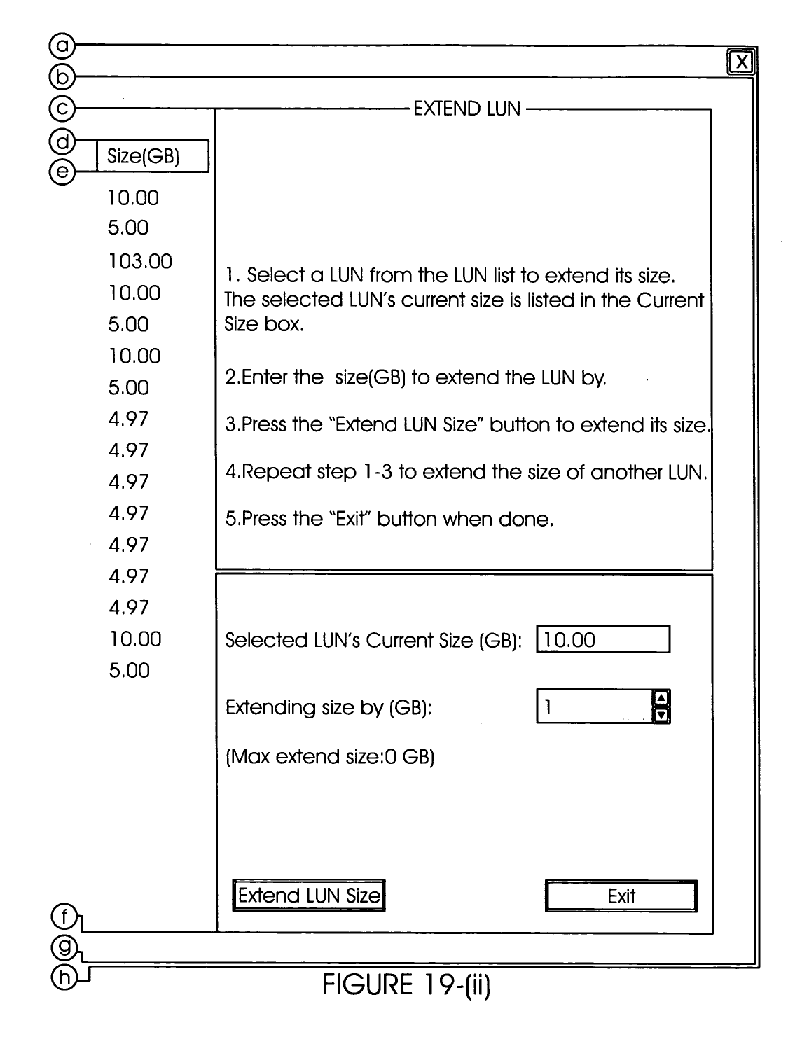

FIG. 19 shows a screen shot for extending a LUN. LUN 401 is assigned to sub-system 400 and the user can enter the desirable size.

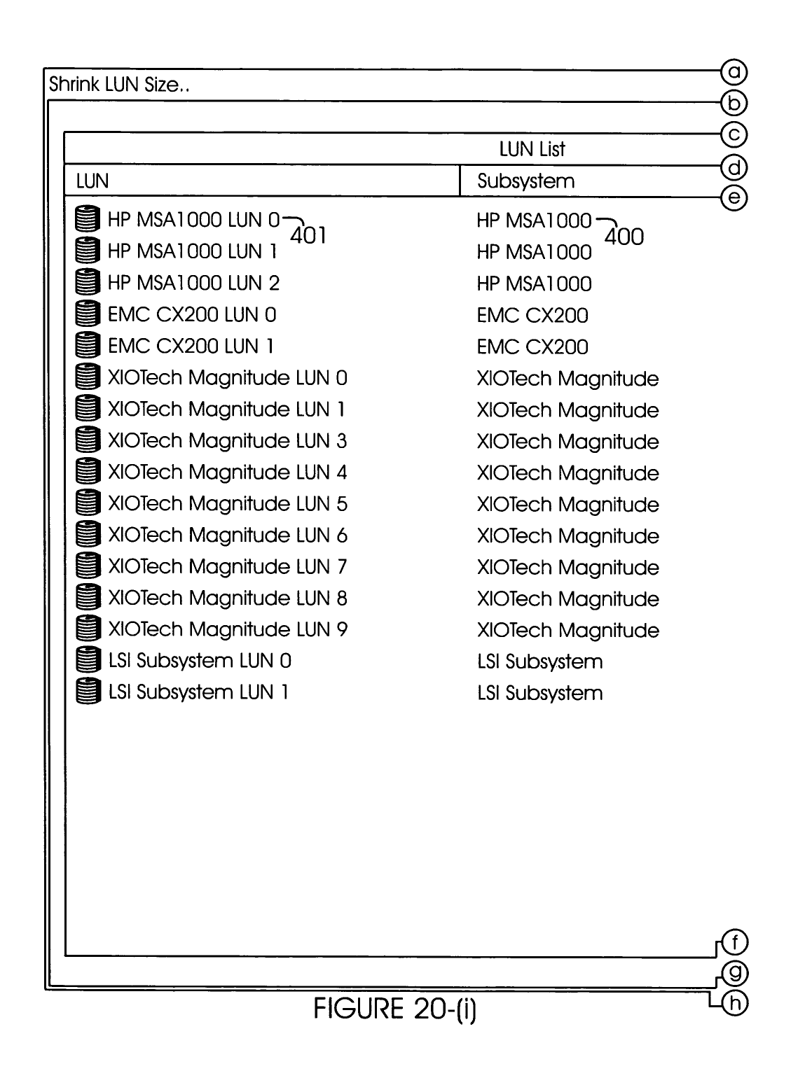

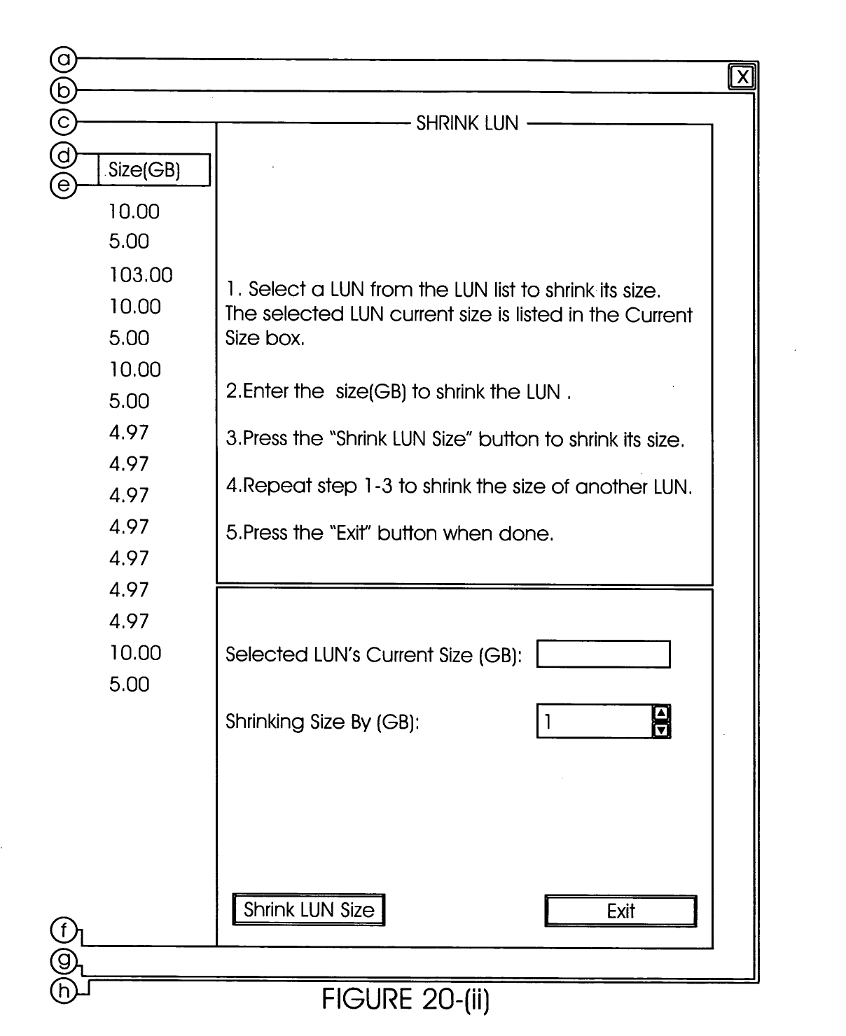

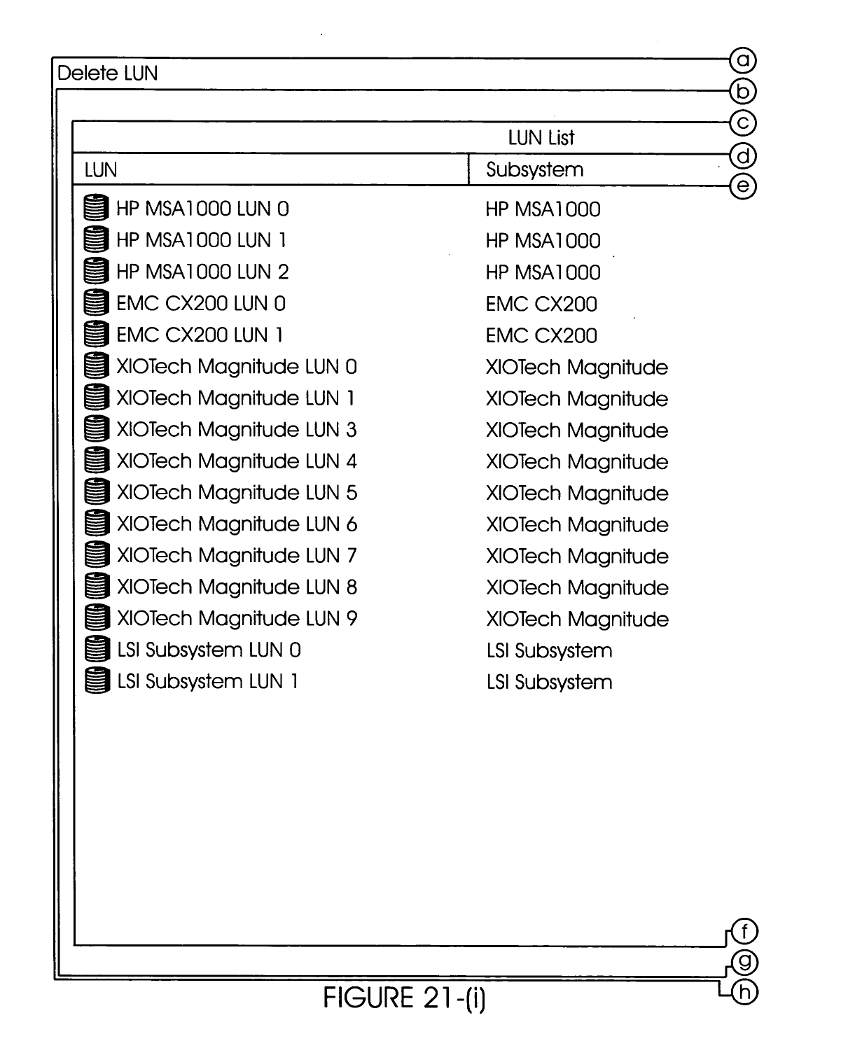

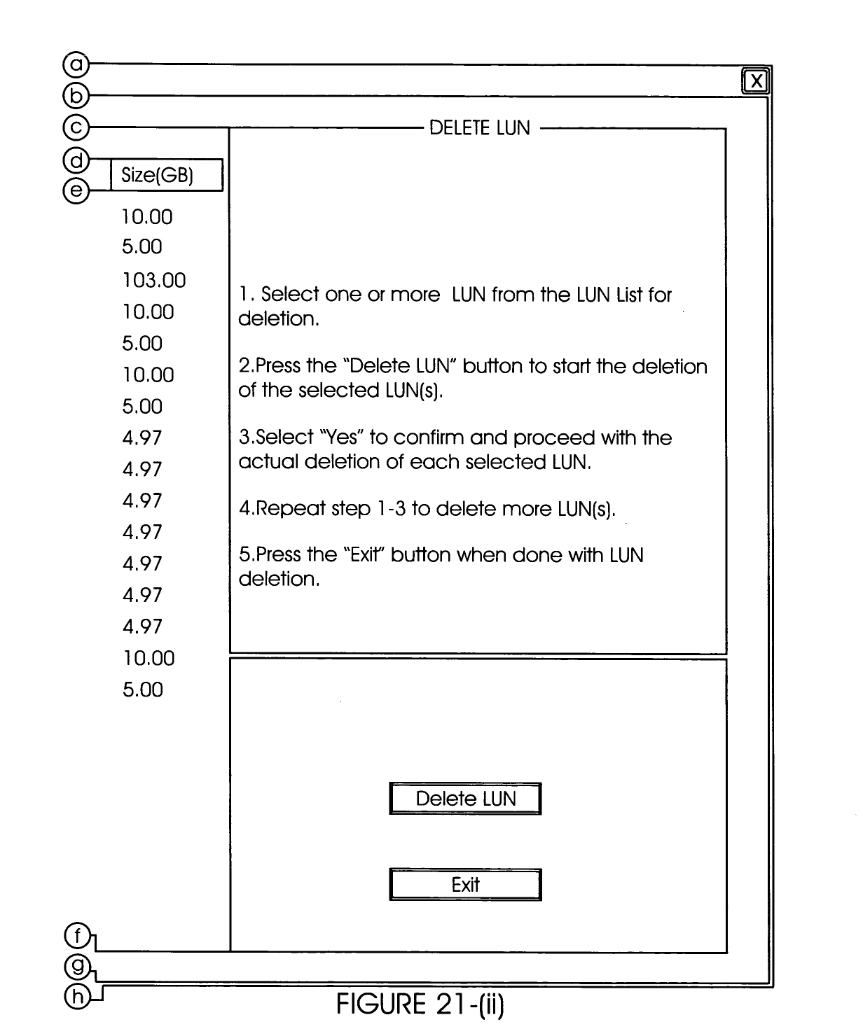

FIG. 20 shows how LUN 401 can be reduced, while FIG. 21 shows how a LUN can be deleted.

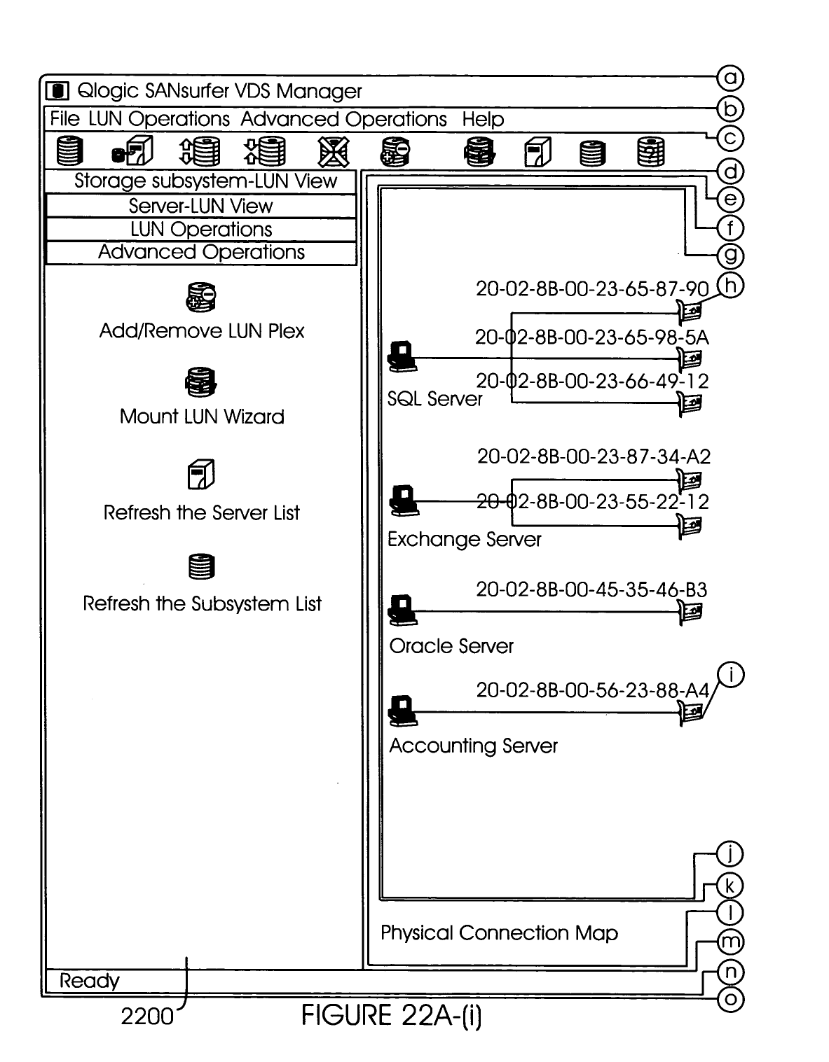

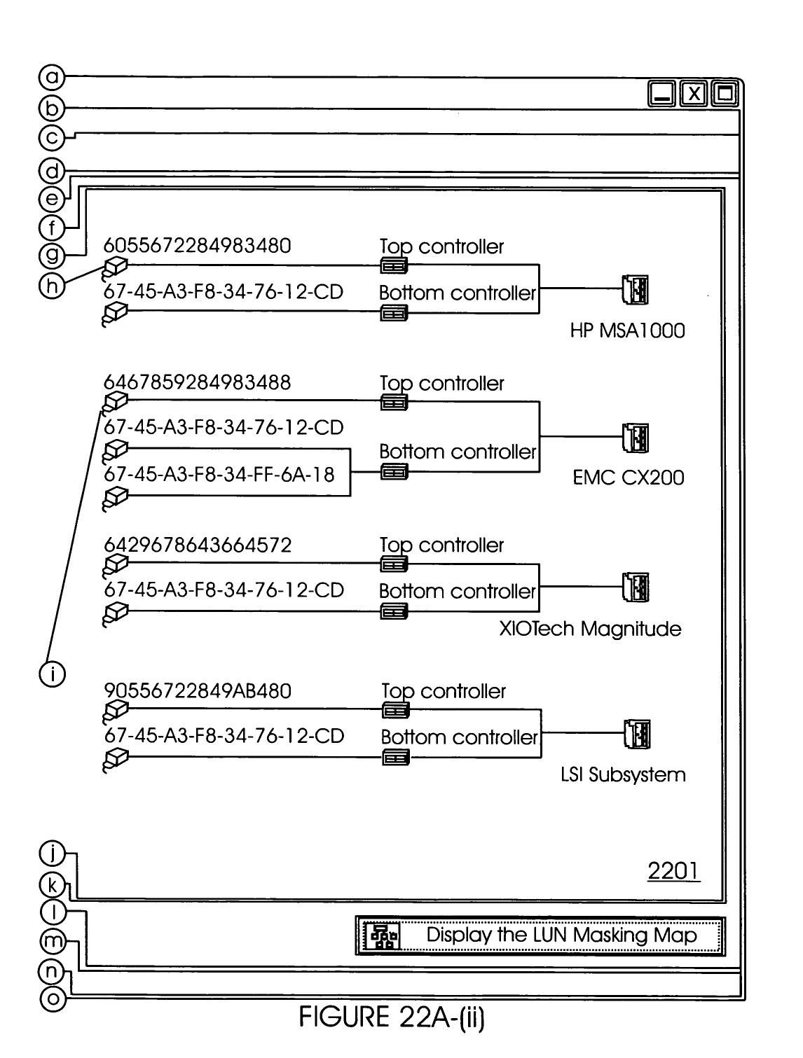

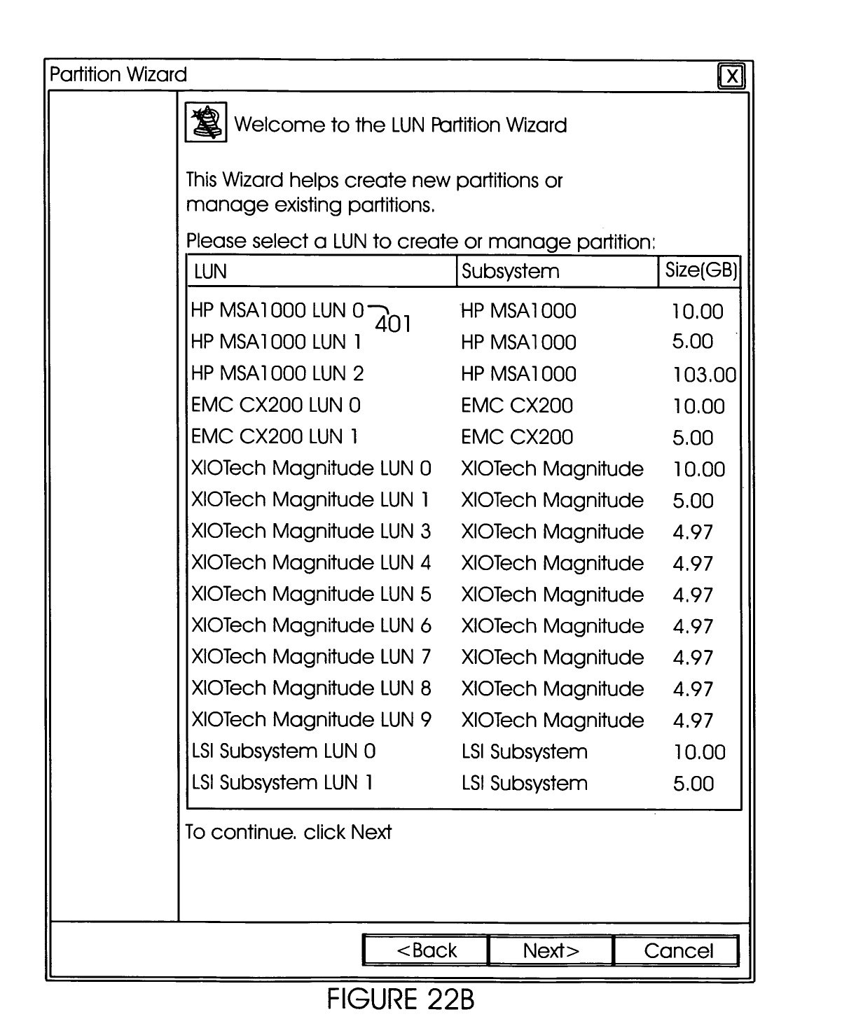

In yet another aspect of the present invention, a LUN can be mounted such that the wizard like utility can partition a LUN. In conventional systems, a dedicated separate disk utility program performs this operation. FIG. 22A shows window 2200 that provides a user with an option to mount a wizard, refresh a server list and/or sub-system list. A physical connection map between the servers and the storage sub-systems is also shown in window 2201.

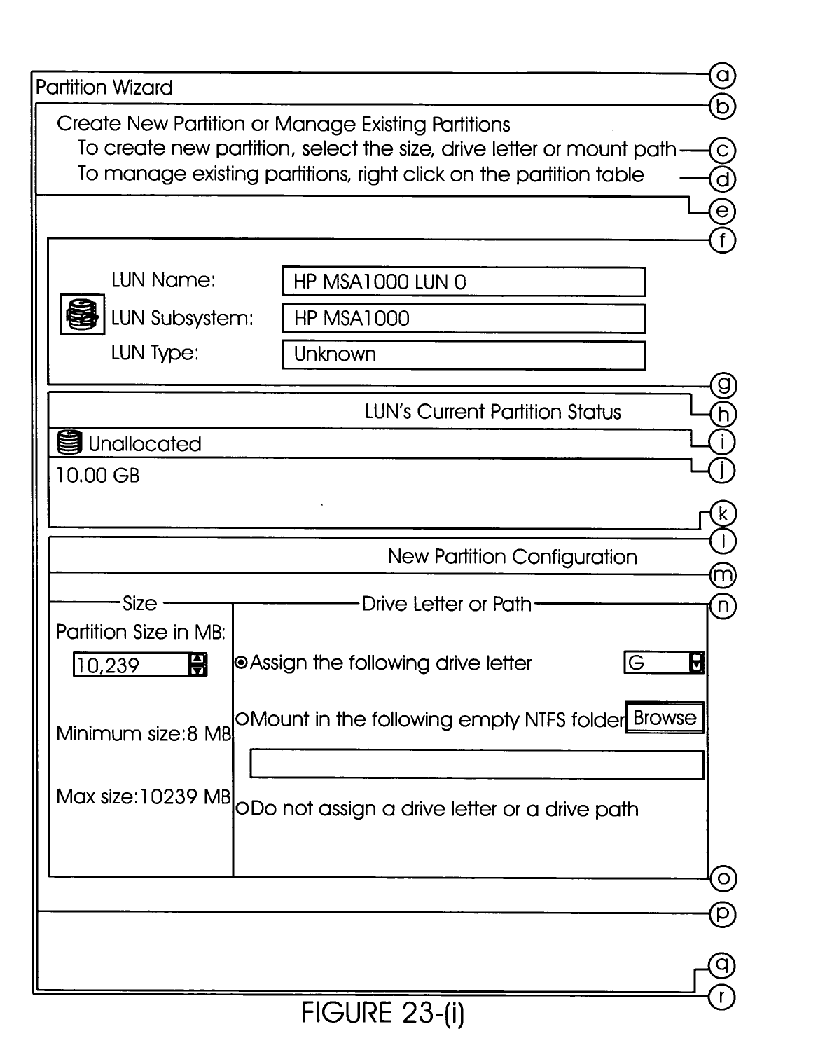

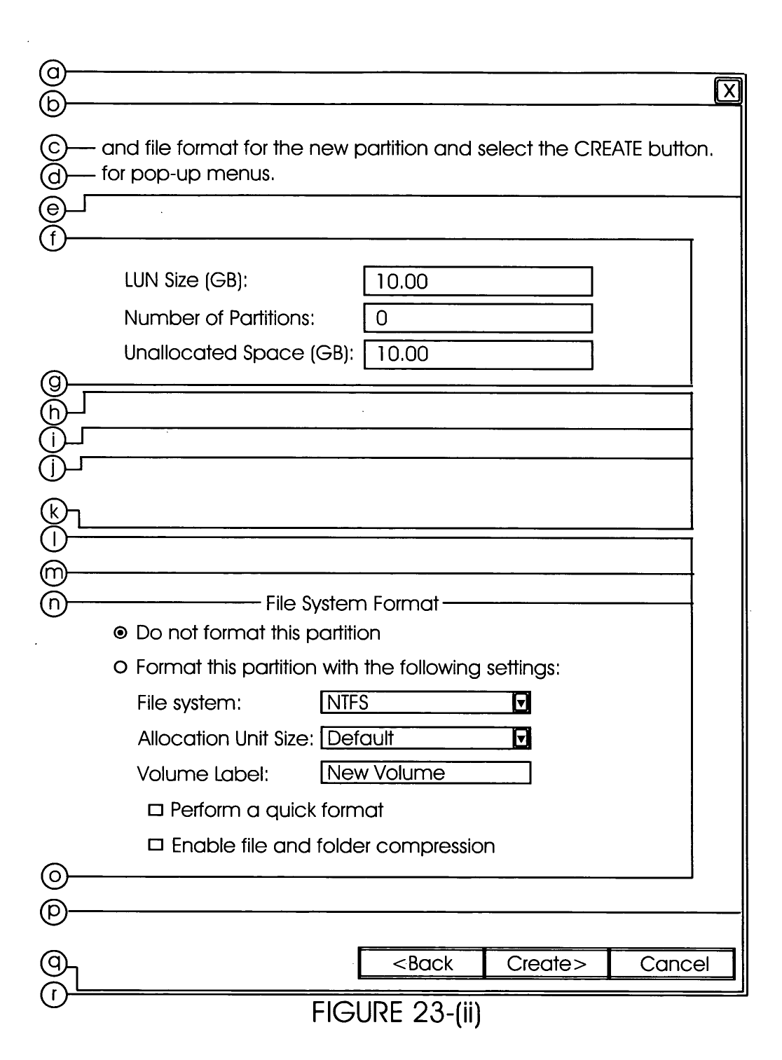

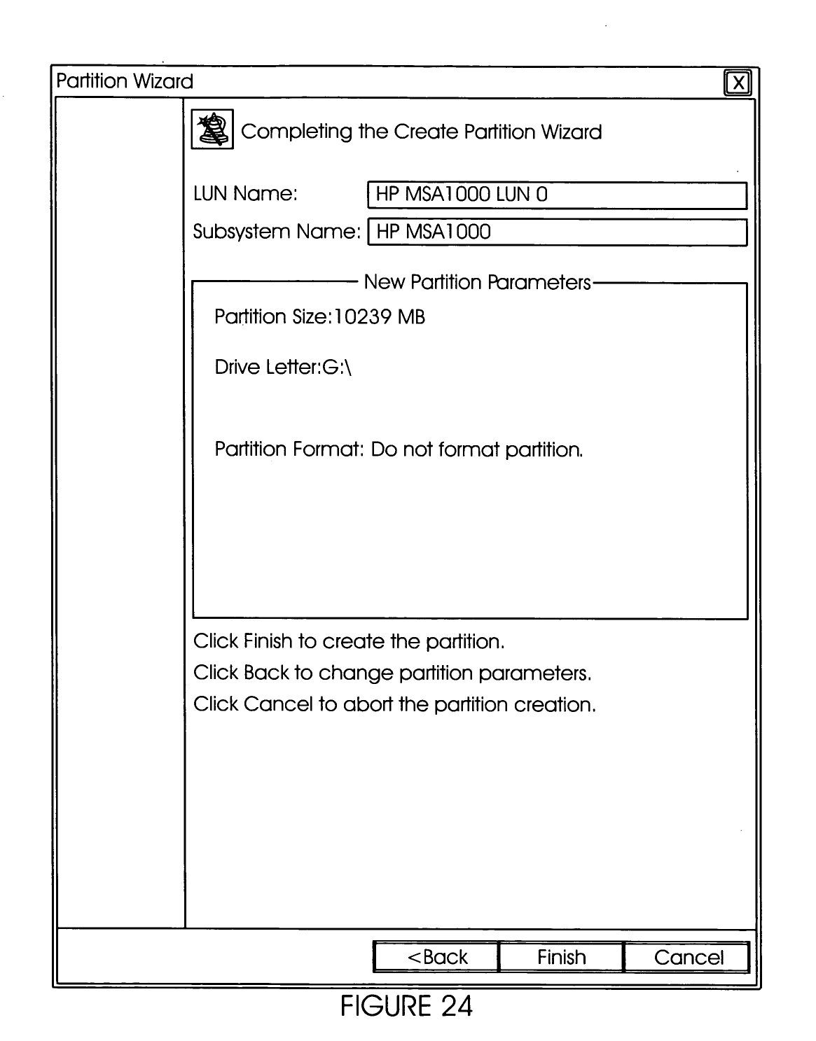

FIG. 22B shows that LUN 401 is selected. FIG. 23 shows how a new partition is created. A size, drive letter and file format is selected. The partition wizard is completed in FIG. 24.

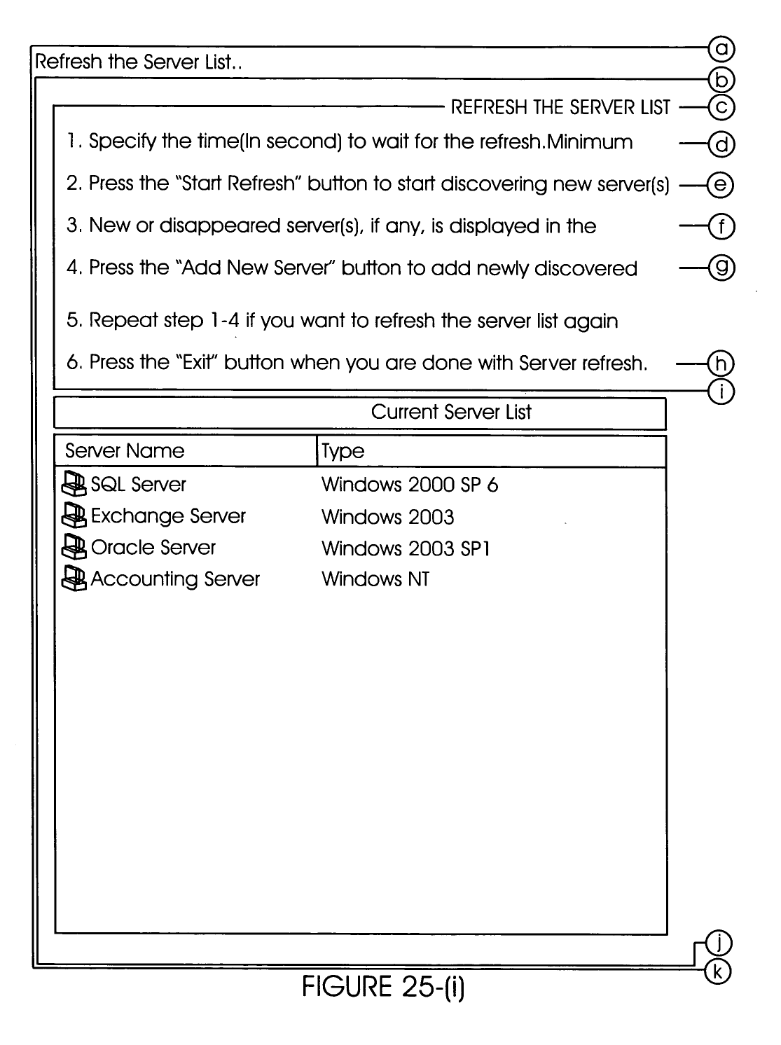

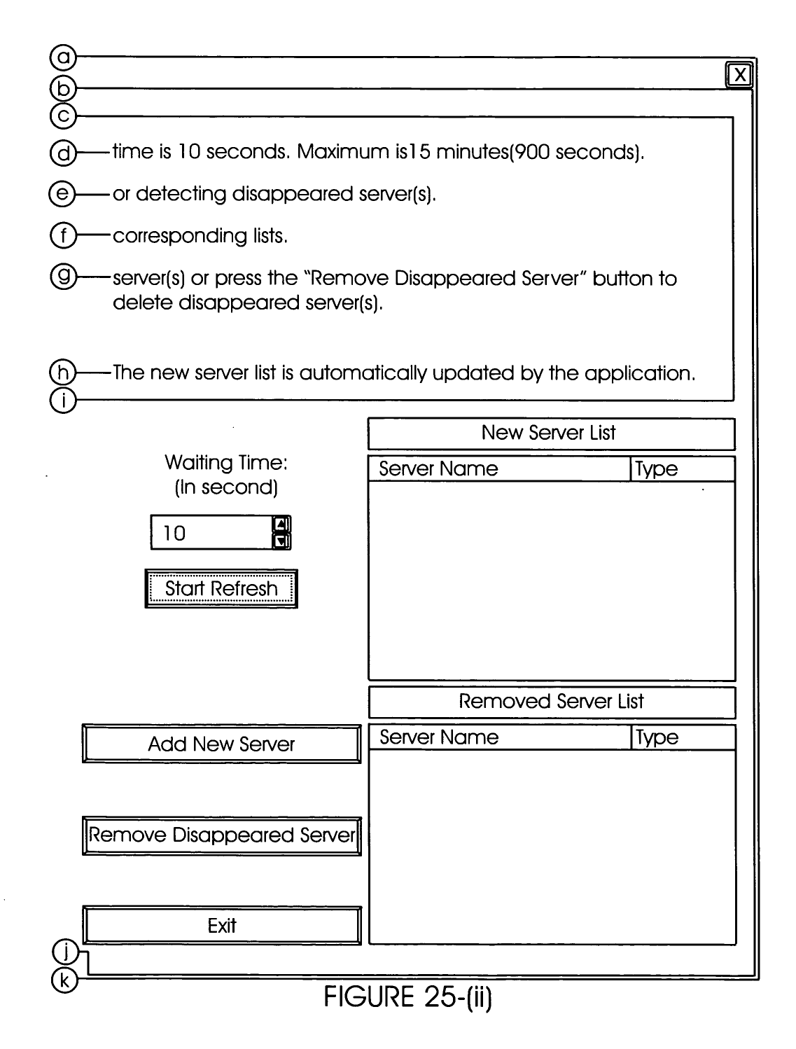

FIG. 25 provides a GUI for a user to refresh a server list automatically. A user can set a time interval (for example, 10 seconds to 15 minutes) for refreshing the server list. Also, a user can add or remove servers from the list.

The adaptive aspects of the present invention allow an administrator to easily manage a storage area network without having to use tedious LUN creation/management code.

Although the present invention has been described with reference to specific embodiments, these embodiments are illustrative only and not limiting. Many other applications and embodiments of the present invention will be apparent in light of this disclosure and the following claims.

1. A method for creating a logical unit number (“LUN”) in a storage area network, comprising:
selecting a storage sub-system from a list of available storage sub-subsystems for which the LUN is created in a wizard like setting, wherein a display attribute may be used for depicting connectivity of the storage sub-system to a server and/or host bus adapter;
configuring the LUN for the selected storage sub-system; and
assigning the LUN to at least one server.

2. A management application for creating a logical unit number (“LUN”) in a storage area network, comprising:
computer executable code for selecting a storage sub-system from a list of available storage sub-subsystems for which the LUN is created, wherein a display attribute may be used for depicting connectivity of the storage sub-system to a server and/or host bus adapter; configuring the LUN for the selected storage sub-system; and assigning the LUN to at least one server.

3. A system for creating a logical unit number (“LUN”) in a storage area network, comprising:
a management application that includes computer executable code for selecting a storage sub-system from a list of available storage sub-subsystems for which the LUN is created, wherein a display attribute may be used for depicting connectivity of the storage sub-system to a server and/or host bus adapter; configuring the LUN for the selected storage sub-system; and assigning the LUN to at least one server.

4. A graphical user-interface for creating a logical unit number (“LUN”) in a storage area network, comprising:
a utility in a wizard like setting for selecting a storage sub-system from a list of available storage sub-subsystems for which the LUN is created wherein a display attribute may be used for depicting connectivity of the storage sub-system to a server and/or host bus adapter; configuring the LUN for the selected storage sub-system; and assigning the LUN to at least one server.

5. A method for operating on a logical unit Number (“LUN”) in a storage area network, comprising: extending an existing LUN by using a graphical user interface and selecting the LUN associated with a storage sub-system and a server and providing a size for extending the LUN.

6. The method of claim 5, further comprising: shrinking an existing LUN by using a graphical user interface and selecting the LUN associated with a storage sub-system and a server and providing a size for shrinking the LUN.

7. The method of claim 5, further comprising: deleting an existing LUN by using a graphical user interface and selecting the LUN associated with a storage sub-system and a server.

8. The method of claim 5, further comprising: partitioning a LUN in a wizard like setting by assigning a partition size, and drive letter.
